(19) United States
(12) Patent Application Publication
(10) Pub. No.: US 2015/0169156 A1
(43) Pub. Date: Jun. 18, 2015

(54) Method and Mechanism for Human Computer Interaction

(71) Applicant: REALITYGATE (PTY) LTD., Stellenbosch (ZA)

(72) Inventors: Willem Morkel Van Der Westhuizen, Stellenbosch (ZA); Filippus Lourens Andries Du Plessis, Stellenbosch (ZA); Hendrik Frans Verwoerd Boshoff, Stellenbosch (ZA); Jan Pool, Stellenbosch (ZA)

(21) Appl. No.: 14/407,917

(22) PCT Filed: Jun. 13, 2013
(86) PCT No.: PCT/ZA2013/000042

§ 371 Date: Dec. 12, 2014

(30) Foreign Application Priority Data
Jun. 15, 2012 (ZA) 2012/04407

(51) Int. Cl. G06F 3/0484; G06F 3/01

(52) U.S. Cl. CPC G06F 3/0484; G06F 3/011

(57) ABSTRACT

The method provides a method and engine for human-computer interaction (HCI) on a graphical user interface (GUI). The method includes the step of tracking the position and/or movement of a user's body or part of it relative to and/or with an input device in a control space, facilitating human-computer interaction by means of an interaction engine and providing feedback to the user in a sensory feedback space. Facilitation includes the steps of: establishing a virtual interaction space(vIS); establishing and referencing one or more virtual objects with respect to the interaction space; establishing and referencing one or more focal points in the interaction space in relation to the tracked position and/or movement in the control space; applying one or more mathematical functions or algorithms to determine the interaction between one or more focal points and the virtual objects in the interaction space, and/or to determine one or more commands to be executed; and applying a mathematical function or algorithm to determine what content of the interaction space is to be presented to the user as feedback, and in which way the content is to be displayed.

### TECHNICAL FIELD OF THE INVENTION

This invention relates to human-computer interaction.

### BACKGROUND TO THE INVENTION

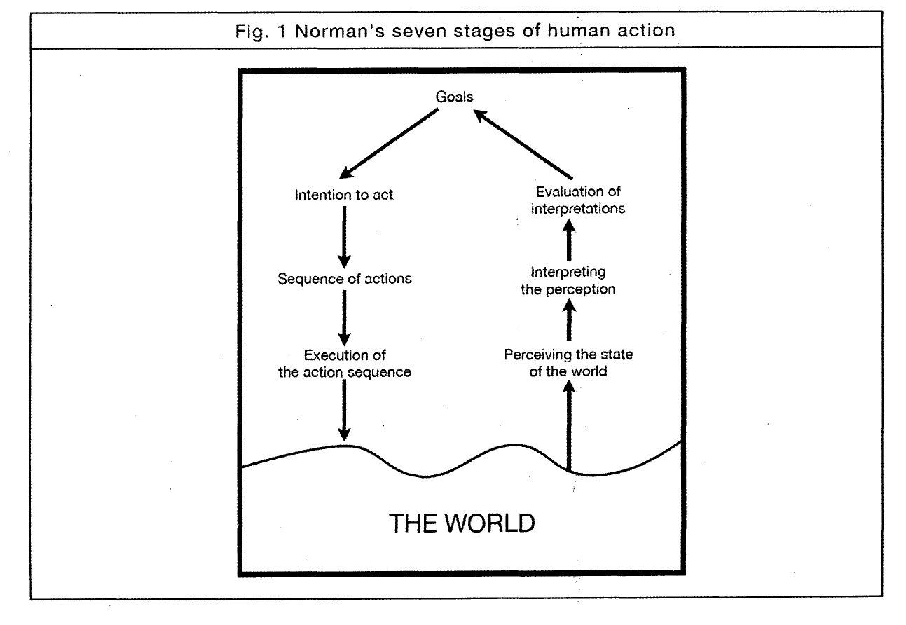

The fundamental concepts of human-computer interaction (HCI) have been addressed in many ways and from various perspectives [1-4]. Norman [5] separates human action into the seven stages appearing in FIG. 1. He derives the stages from two “aspects” of human action, namely execution and evaluation. These aspects have human goals in common; and they are repeated in a cycle closed by the effects of the action on the state of what he labels as “the world.”

Action involves objects, including the human body or limbs used in carrying out the action. Objects without action may be uninteresting, but action without objects seems impossible. Actions take time and objects occupy space, so both time and space enter into interaction.

### Action and Interaction in Time

The motor part of human action (roughly Norman's execution aspect) is widely modelled by “Fitts' Law” [6]. It is an equation for the movement time (MT) needed to complete a simple motor task, such as reaching for and touching a designated target of given size over some distance [7]. For one dimensional movement, this equation has two variables: the distance or movement amplitude (A) and the target size or width (W); and also two free parameters: a and b, chosen to fit any particular set of empirical data:

$$MT = a + {blog}_{2} ( 1 + \frac{A}{W} )$$

The perceptual and choice part of human action (roughly Norman's evaluation aspect) is modelled by “Hick's Law” [8], an equation for the reaction time (RT) needed to indicate the correct choice among N available responses to a stimulus, randomly selected from a set of N equally likely alternatives. This equation only has one variable, the number N, and one parameter K for fitting the data:

RT=K log₂(1+N)

No human performance experiment can be carried out without a complete human action involving both execution and evaluation (Fitts refers to “the entire receptor-neural-effector system” [6]), but experimental controls have been devised to tease apart their effects. For example, Fitts had his subject “make rapid and uniform responses that have been highly overlearned” while he held “all relevant stimulus conditions constant,” to create a situation where it was “reasonable to assume that performance was limited primarily by the capacity of the motor system” [6]. On the other hand, Hick had his subject's fingers resting on ten Morse keys while awaiting a stimulus, in order to minimise the required movement for indicating any particular response [8].

The studies of both Fitts [6] and Hick [8] were inspired by and based on then fresh concepts from information theory as disseminated by Shannon and Weaver [9]. While Fitts' Law continues to receive attention, Hick's Law remains in relative obscurity [10].

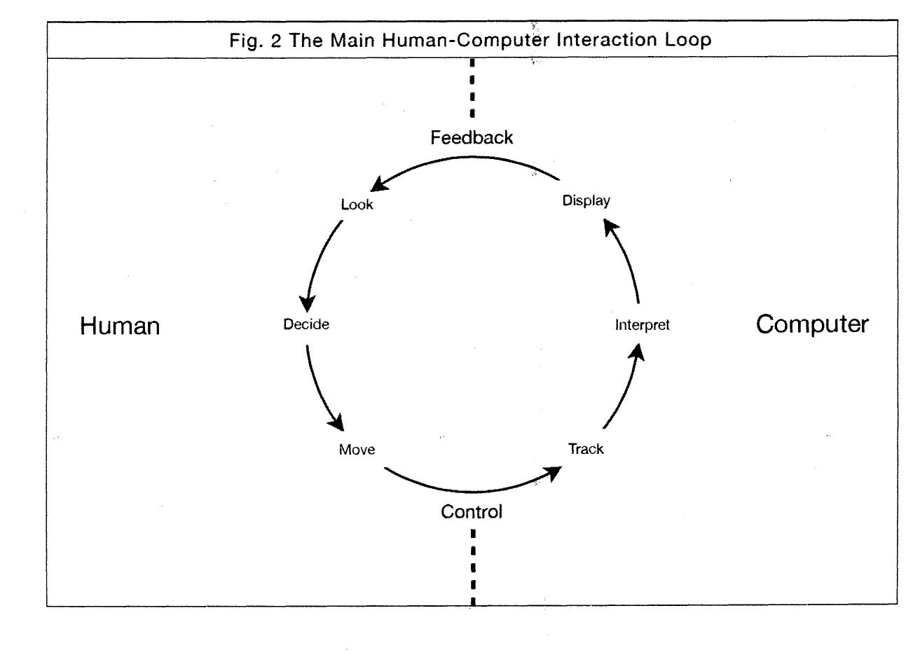

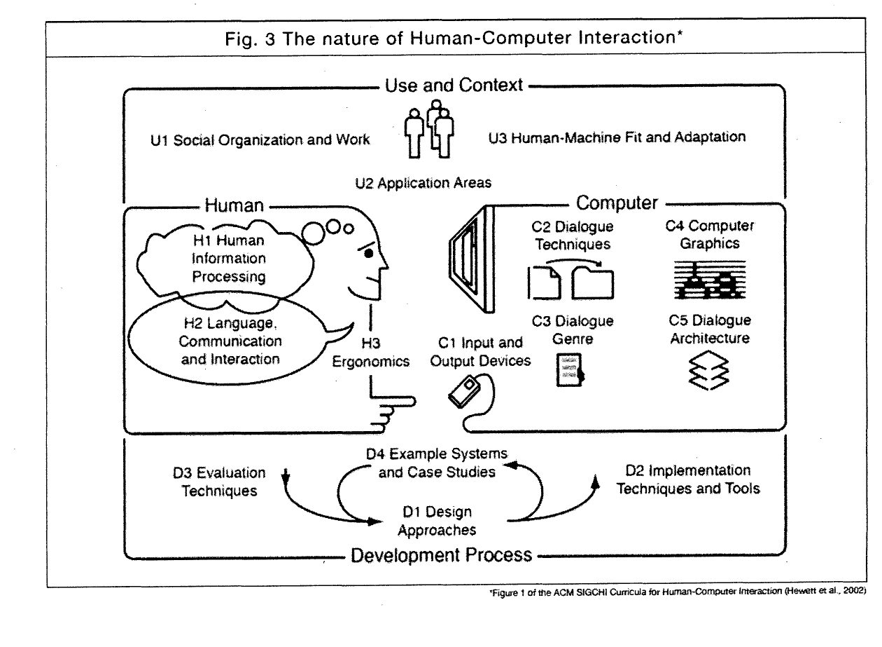

The interaction between human and computer takes the form of a repeating cycle of reciprocal actions on both sides, constituting the main human-computer interaction loop. FIG. 2 shows this view, where Norman's “world” is narrowed to the computer, while visual perception is emphasized. The human action has been analysed into the three stages or low-level actions look-decide-move, with the computer action mirroring that to some extent with track-interpret-display. Although each stage feeds information to the next in the direction indicated by the arrows, all six low-level actions proceed simultaneously and usually without interruption. The stages linked together as shown comprise a closed feedback loop, which forms the main conduit for information flow between human and computer. The human may see the mouse while moving it or change the way of looking based on a decision, thereby creating other feedback channels inside this loop, but such channels will be regarded as secondary.

The given main HCI loop proceeds inside a wider context, not shown in FIG. 2. On the human side for example, the stage labelled decide is also informed by a different loop involving his or her intentions, while that loop has further interaction with other influences, including people and the physical environment. On the computer side, the stage labelled interpret is also informed by a further loop involving computer content, while that loop in its turn may have interaction with storage, networks, sensors, other people, etc. Even when shown separately as in FIG. 2, the main interaction loop should therefore never be thought of as an isolated or closed system. In this context, closed loop is not the same as closed system.

The human action may be regarded as control of the computer, using some form of movement, while the computer provides visual feedback of its response, enabling the human to decide on further action. The cycle repeats at a display rate (about 30 to 120 Hz), which is high enough to create the human illusion of being able to directly and continuously control the movement of objects on the screen. The computer may be programmed to suspend its part of the interaction when the tracking of human movement yields a null result for long enough, but otherwise the loop continues indefinitely.

A more comprehensive description of HCI and its context is provided by the ACM model from the SIGCHI Curricula for human-computer interaction [11], shown in FIG. 3. The computer side may be divided into three parts which map directly to the three computer actions of FIG. 2:
Input—human control movements are tracked and converted into input data
Processing—the input data is interpreted in the light of the current computer state, and output data is calculated based on both the input data and the state
Output—the output data is presented to the human as feedback (e.g. as a visual display)

The input and output devices are physical objects, while the processing is determined by data and software. Input devices may range from keyboard, mouse, joystick and stylus to microphone and touchpad or pick-up for eyegaze and electrical signals generated by neurons. Output devices usually target vision, hearing or touch, but may also be directed to other senses like smell and heat. Visual display devices have long dominated what most users consider as computer output.

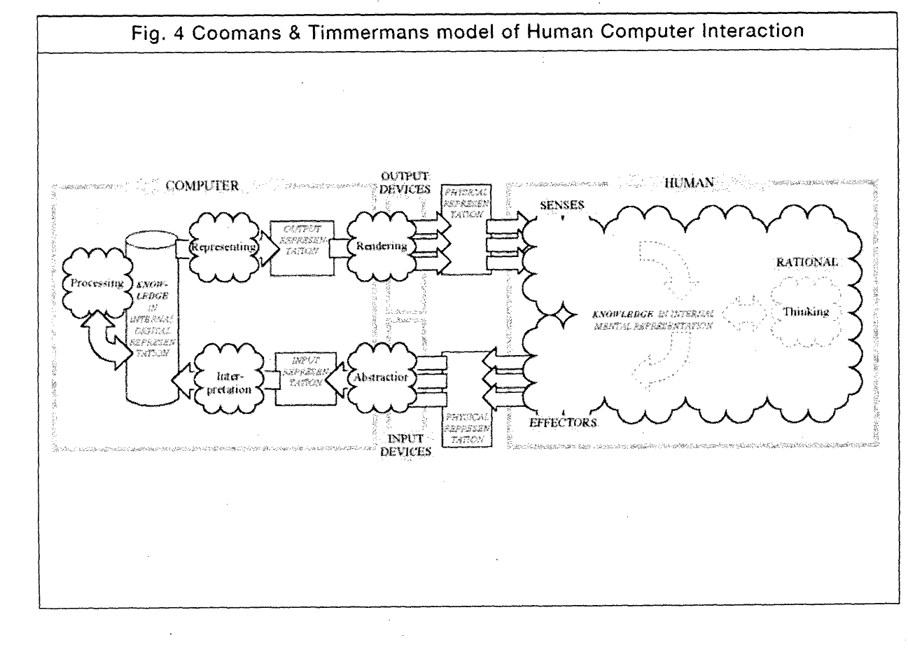

A model of human-computer interaction that contains less context but a more detailed internal structure than that of the ACM, is the one of Coomans & Timmermans [12] shown in FIG. 4. In their intended application domain of virtual reality user interfaces, they claim that a two-step transformation is always required for computer input (namely abstraction and interpretation) and computer output (namely representing and rendering).

### Objects and Spaces

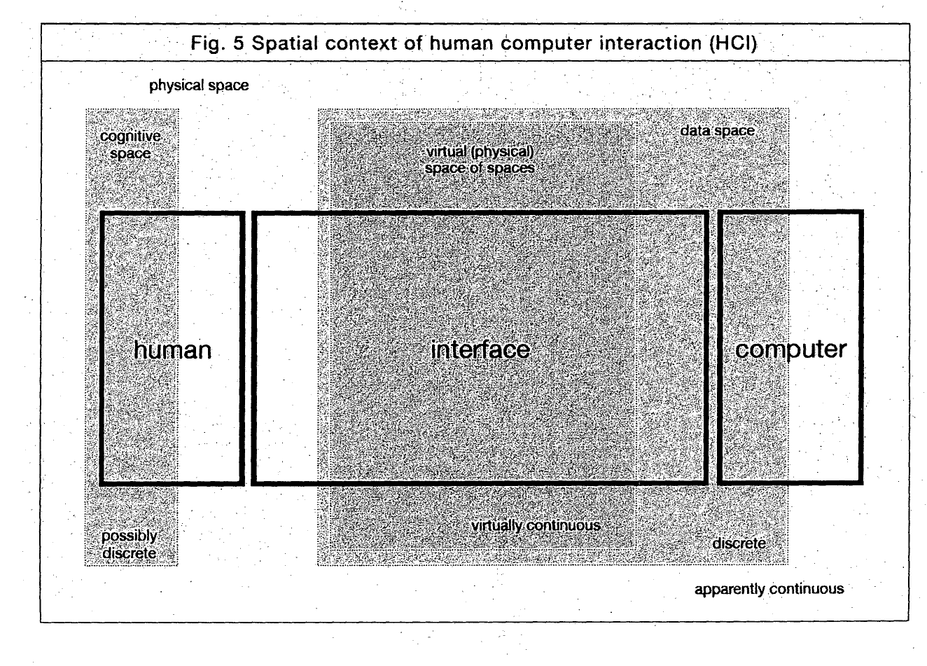

The inventors' view of the spatial context of HCI is presented in FIG. 5, where the three extended objects human, interface and computer are shown in relation to four major spaces: physical, cognitive, data and virtual. The inventors' segmentation of the problem exhibits some similarities to that of FIG. 4, but the boxes containing the term representation are paralleled by spaces for purposes of the invention.

In contrast with the previously shown models, a complete conceptual separation is made here between the interface and the computer on which it may run. The interface includes most parts of the computer accessible to the casual user, in particular the input and output devices, but also other more abstract parts, as will be explained below. It excludes all computer subsystems not directly related to human interaction.

This objectification of the interface actually implies the introduction of something that may more properly be called an extended interface object, in this case an interface computer or an interface engine. This specification will mostly continue to refer to the object in the middle as the interface, even though it creates a certain paradox, in that two new interfaces inevitably appear, one between the human and the interface (object) and another between the interface (object) and the computer. In this model, the human does not interact directly with the computer, but only with the interface (object).

From the point of view of the end user, such a separation between the interface computer and the computer proper may be neither detectable nor interesting. For the system architect however, it may provide powerful new perspectives. Separately, the two computers may be differently optimised for their respective roles, either in software or hardware or both. The potential roles of networking, cloud storage and server side computing are also likely to be different. The possibility exists that, like GPUs vs CPUs, the complexity of the interface computer or interaction processing unit (IPU) may rival that of the computer itself.

Everything in FIG. 5 is assumed to exist in the same encompassing physical space, which is apparently continuous in the sense of having infinitely divisible units of distance. Furthermore each of the three extended objects of interest straddles at least two different spaces. The (digital) computer's second space is an abstract and discrete data space, while the cognitive space of the human is also tentatively taken to be discrete. One may recognize a certain thirdness about our interface object, not only in its explicit role as mediator between human and computer, but also in its use of a third category of virtual spaces in addition to its physical presence with respect to the human and its data presence on the computer side.

Due to their representational function, the virtual spaces of the interface tend to be both virtually physical and virtually continuous, despite their being implemented as part of the abstract and discrete data space. The computer processing power needed to sustain a convincing fiction of physicality and continuity has only become widely affordable in the last decade or two, giving rise to the field of virtual reality, which finds application in both serious simulations and in games. In FIG. 5, the representation of virtual reality would be situated in the interface.

Information transfer or communication between two extended objects takes place in a space shared by both, while intra-object information or messages flow between different parts (sub-objects) of the extended object, where the parts may function in different spaces.

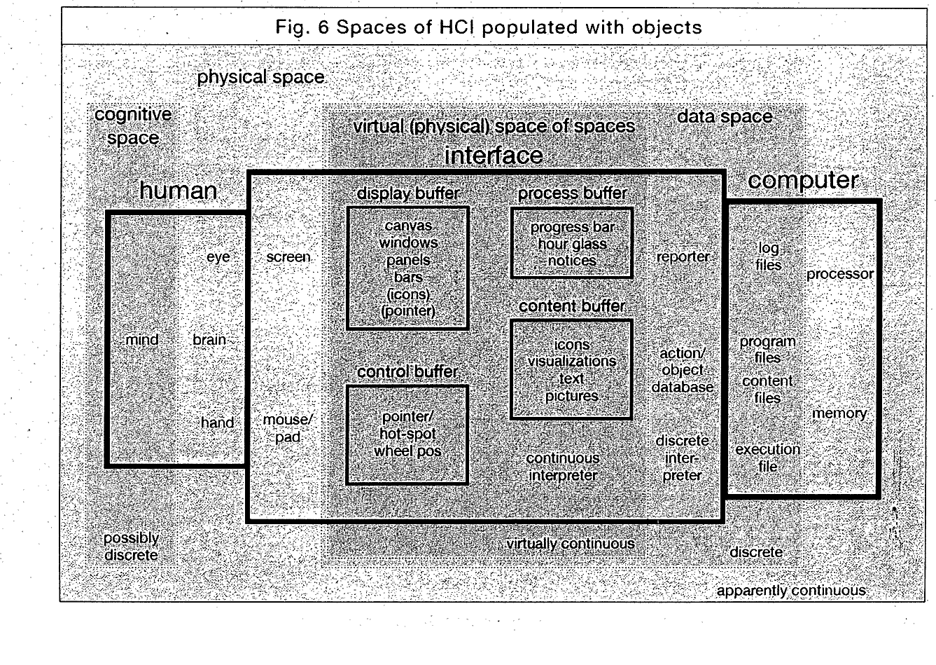

FIG. 6 shows the same major spaces as FIG. 5, but populated with objects that form part of the three extended objects. This is meant to fill in some details of the model, but also to convey a better sense of how the spaces are conceived. The human objects shown, for example, are the mind in cognitive space, and the brain, hand and eye in physical space.

Four virtual spaces of the interface are also shown, labelled as buffers in accordance with standard usage. Other terms are used in non-standard ways, for example, the discrete interpreter in the data space part of the interface is commonly called the command line interpreter (CLI), but is named in the former way here to distinguish it from a continuous interpreter placed in the virtual space part. Information flow is not represented in FIG. 6, because it results in excessive clutter, but it may be added in a fairly straightforward way.

### Human Motor Space and Visual Space Meet Computer Control Space and Display Space Respectively

The position, orientation, size and abilities of a human body create its associated motor space. This space is the bounded part of physical space in which human movement can take place, eg in order to touch or move an object. Similarly, a visual space is associated with the human eyes and direction of gaze. The motor and perceptual spaces may be called private, as they belong to, move with and may be partially controlled by a particular individual. Physical space in contrast, is public. By its nature, motor space is usually much smaller than the perceptual spaces.

The position, orientation, size and abilities of a computer input device create its associated control space. It is the bounded part of physical space in which the computer can derive information from the human body by tracking some human movement or its effect. The limited physical area of the computer display device constitutes display space, where the human can in turn derive information from the computer by observing the display.

The possibility of interaction is predicated on a usable overlap between the motor and control spaces on one hand and between the visual and display spaces on the other. Such spatial overlap is possible because all the private spaces are subsets of the same public physical space. The overlap is limited by objects that occupy some part of physical space exclusively, or by objects that occlude the signals being observed.

Other terms may be used for these spaces, depending on the investigator's perspective and contextual emphasis, including input space and output space, action space and observation space, Fitts [6] space and Hick [8] space.

A special graphical pointer or cursor in display space is often used to represent a single point of human focus. The pointer forms one of the four pillars of the classic WIMP graphical user interface (GUI), the others being windows, icons and menus. A physical pointing device in control space may be used to track human movement, which the computer then maps to pointer movement in display space.

Doing something in one space and expecting a result in another space at a different physical location is an example of indirection; for instance moving a mouse (horizontally) in control space on the table and observing pointer movement (vertically) in display space on the screen. Another example is the use of a switch or a remote control, which achieves indirect action at a distance.

Perhaps more natural is the arrangement found in touch sensitive displays, where the computer's control and display spaces are physically joined together at the same surface. One drawback of this is the occlusion of the display by the fingers, incidentally highlighting an advantage of spatial indirection.

### The C-D Function

The HCI architect can try to teach and seduce, but do not control the human, and therefore only gets to design the computer side. Thus, of the four spaces, only the computer's control and display spaces are up for manipulation. With computer hardware given, even these are mostly fixed. So the software architect is constrained to designing the way in which the computer's display output will change in response to its control input. This response is identical to the stage labeled “interpret” in FIG. 2, and is characterized by a relation variously called the input-output, control-display or C-D function.

The possible input-output mapping of movements in control space to visual changes in display space is limited only by the ingenuity of algorithm developers. However, the usual aim is to present humans with responses to their movements that make intuitive sense and give them a sense of control within the context of the particular application. These requirements place important constraints on the C-D function, inter alia in terms of continuity and proportionality.

When defining the C-D function, the computer is often treated as a black box, completely described from the outside by the relation between its outputs and its inputs. Realization of the C-D function is achieved inside the computer by processing of the input data derived from tracking in the context of the computer's internal state. Early research led to the introduction of non-linear C-D functions, for example ones that create pointer acceleration effects on the display which are not present in control space, but which depend on pointing device speed or total distance moved.

The Classic GUI from the Current Perspective

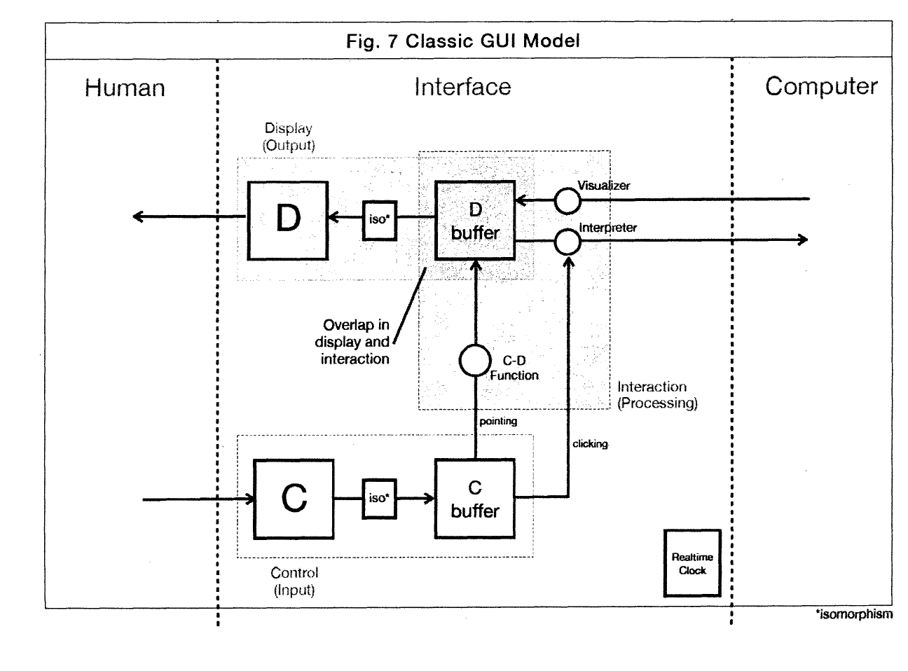

FIG. 7 contains a schematic model of the classic GUI, which shows a simplified concept of what happens inside the black box, when assuming the abovementioned separation between the interface and the computer beyond it. The input data derived from control space is stored inside the machine in an input or control buffer. Similarly, a display buffer is a special part of memory that stores a bitmap of what is displayed on the screen. Any non-linear effect of the input transducers is usually counteracted by an early stage of processing. The mapping between the physical control space and its control or input buffer is therefore shown as an isomorphism. The same goes for the mapping between the display buffer and the physical display space.

The GUI processing of interaction effects are taken to include the C-D function and two other elements called here the Visualizer and the Interpreter. The Visualizer is responsible for creating visualizations of abstract data, e.g. in the form of icons, pictures or text, while the Interpreter generates commands to be processed by the computer beyond the interface.

Input processing in this scheme is neatly separated from interaction processing, but an overlap exists between interaction processing and display processing. The locus of this overlap is the display buffer, which contains an isomorphic representation of what appears on the screen. This approach was probably adopted to save memory during the early days of GUI development in the 1980's. The overlap currently creates some constraints on interaction processing, especially in terms of resolution. Some games engines have a separate internal representation of the game world to overcome this limitation and to create other possibilities.

The experienced GUI user's attention is almost entirely concentrated on display space, with motor manipulations automatically varied to achieve some desired visual result. In this sense, the display space is the ultimate reference for all objects and actions performed by either human or computer in any space that eventually maps to display space.

Computer Games from the Current Perspective

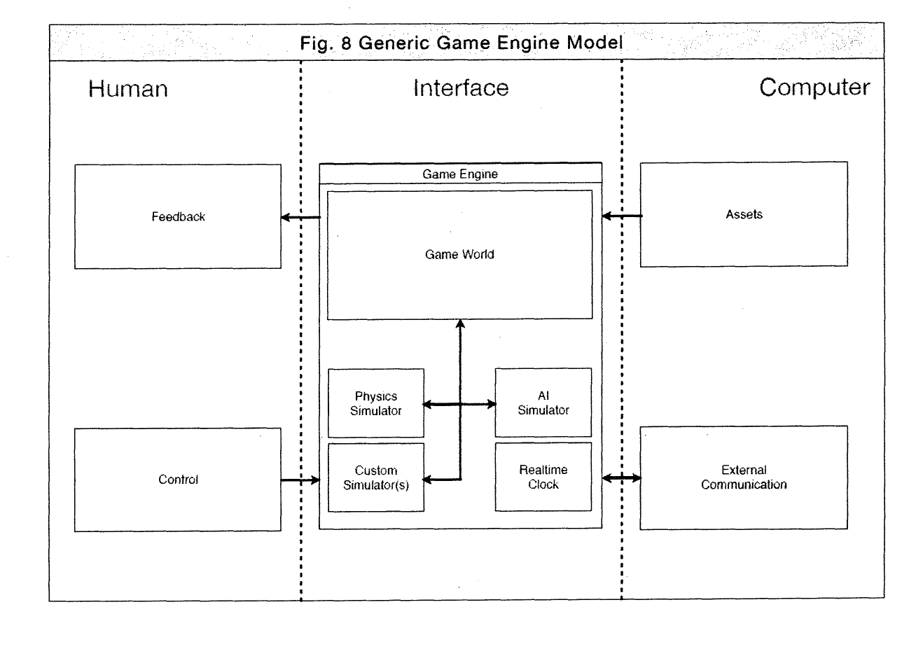

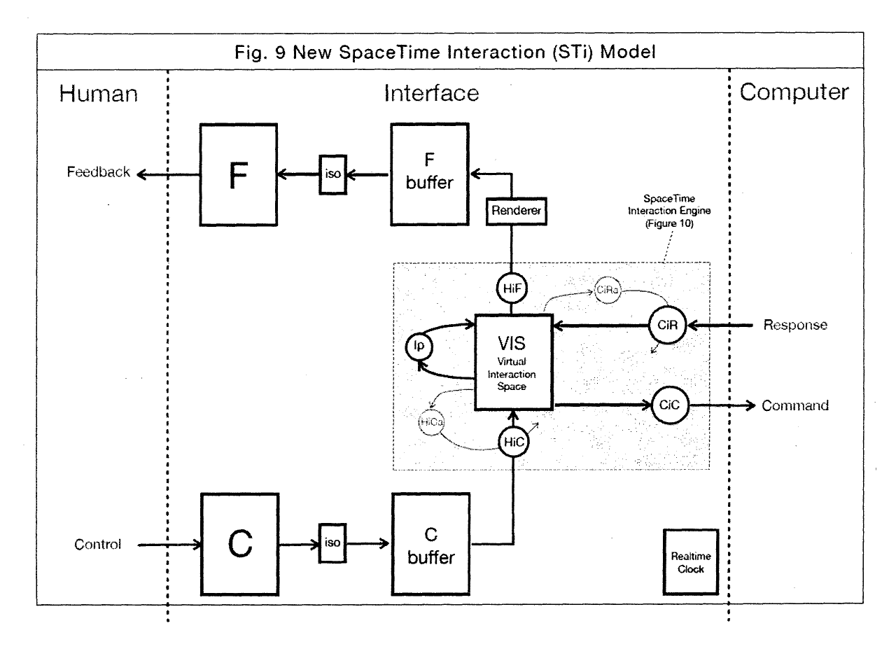

Computer games often build on virtual reality and always need to provide methods for interaction. A model for a generic game engine from the current perspective is shown in FIG. 8.

A game engine provides a reusable software middleware framework, which may be platform independent, and which simplifies the construction of computer based games. A game engine framework is typically built around a component-based architecture, where developers may have the option to replace or extend individual components. Typical components may include high-level abstractions to input devices, graphics, audio, haptic feedback, physics simulation, artificial intelligence, network communication, scripting, parallel computing and user interaction. A game engine is responsible for creating the game world (game state) from a description of the game and game object models. The game engine dynamically updates the game state based on the game rules, player interaction and the response of real opponents and numerous simulators (e.g. physics simulator and artificial intelligence).

There is a huge spectrum of game types. Sometimes games use GUI elements for interaction in parts of the game (e.g. configuration and control panels), but the majority of games rely on well-defined game data and objects, custom interactions in reaction to player input, actions of opponents (real or artificial) and the current game state.

It is important to note that in many game types, the game world objects are seldom under the player's (user's) control and that selection plays a small role in the game dynamics. Even if the player does nothing (no controlled input) the game world state will continue to evolve. The passing of time is explicit and plays an important role in many game types. Finally, in most games the game objects are not co-operative with respect to the player's actions; more often objects act competitively, ignore the player's actions or are simply static.

Some Other Considerations from the Known Art of Interaction

The Apple Dock [13] allows interaction based on a one-dimensional fish-eye distortion. The distortion visually magnifies some icons close to the pointer. This has some perceptual advantages, but no motor or Fitts advantage [14]. As a direct result of the magnification, the cursor movement is augmented by movement of the magnified icon in the opposite direction. Therefore this method provides no motor advantage to a user apart from that of a visual aid. The Apple Dock can thus be classified as a visualising tool.

PCT/FI2006/050054 describes a GUI selector tool, which divides up an area about a central point into sectors in a pie menu configuration. Some or all of the sectors are scaled in relation to its relative distance to a pointer. Distance is presumably measured by means of an angle and the tool allows circumferential scrolling. The scaling can be either enlarging or shrinking the sector. The whole enlarged area seems to be selectable and therefore provides a motor advantage to the user. This invention appears aimed at solving the problem of increasing the number of selectable objects on a small screen, such as that of a handheld device.

A similar selector tool is described in U.S. Pat. No. 6,073,036. This patent discloses a method wherein one symbol of a plurality of symbols are magnified proximate a tactile input to both increase visualisation and to enlarge the input area.

Fairly recent work on the C-D function has yielded a technique called semantic pointing [15], in which the C-D function itself is changed when the pointer enters or leaves certain predefined meaningful regions of display space. This may be regarded as a form of adaptation controlled by a feedback signal, and it does provide a motor advantage.

What these methods lack is a cohesive and general interaction engine and methods of using it, which (i) separates input and output processing from interaction processing, (ii) provides a structured set of processors related to a rich spatial representation containing the elements taking part in the interaction, and (iii) allows the possibility of feedback and adaptation. The present invention is intended to fill this gap; thereby enabling the interaction designer to gain clarity and power in performing complex and difficult interaction processing that will enhance the realisation of user intention. Such enhancement may depend on provision to the human of visual advantage, motor advantage, or both. Thus it is an object of the invention to improve human-computer interaction.

### GENERAL DESCRIPTION OF THE INVENTION

The invention is now described with reference to the accompanying drawings, in which:

FIG. 1 shows Norman's seven stages of human action;

FIG. 2 shows a new analysis of the main Human-Computer Interaction loop, for the purposes of the invention;

FIG. 3 shows the standard ACM model for Human-Computer Interaction in context;

FIG. 4 shows the Coomans & Timmermans model of Human-Computer interaction, as developed for virtual reality interfaces;

FIG. 5 shows diagrammatically the spatial context of human-computer interaction (HCI), in accordance with the invention;

FIG. 6 shows diagrammatically the Spaces of HCI populated with objects, according to the invention;

FIG. 7 shows diagrammatically a model of the well-known GUI, as viewed from the current perspective;

FIG. 8 shows diagrammatically a model of a generic games engine, as viewed from the current perspective;

FIG. 9 shows diagrammatically the proposed new model of HCI, according to the invention;

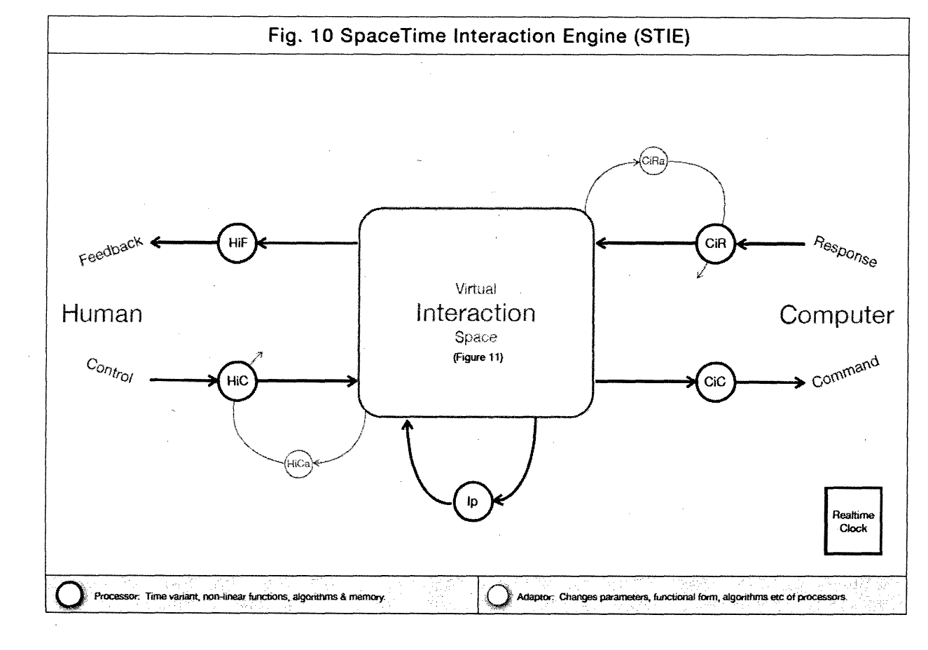

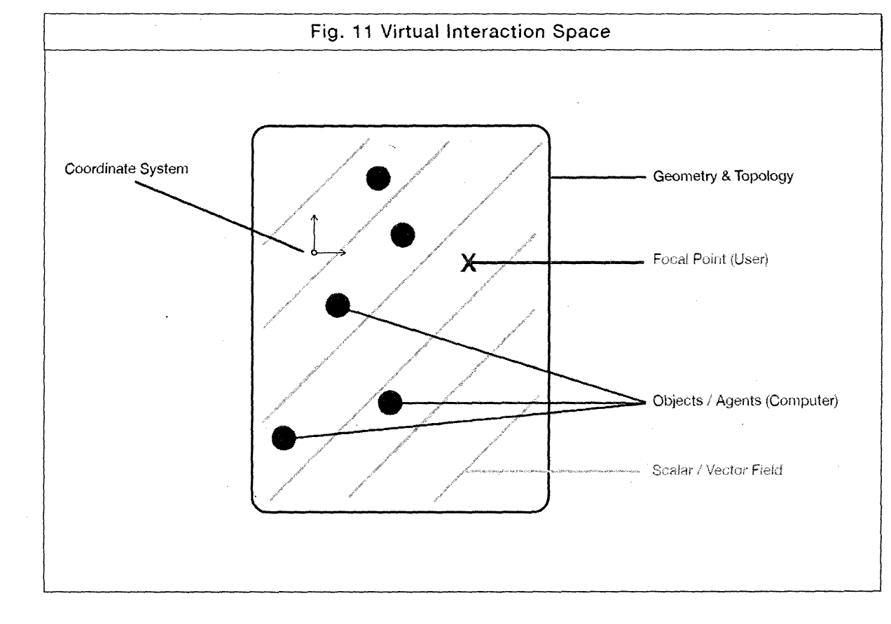

FIG. 10 shows diagrammatically details of the proposed new interaction engine, according to the invention;

FIG. 11 shows diagrammatically the Virtual Interaction Space (vIS), according to the invention;

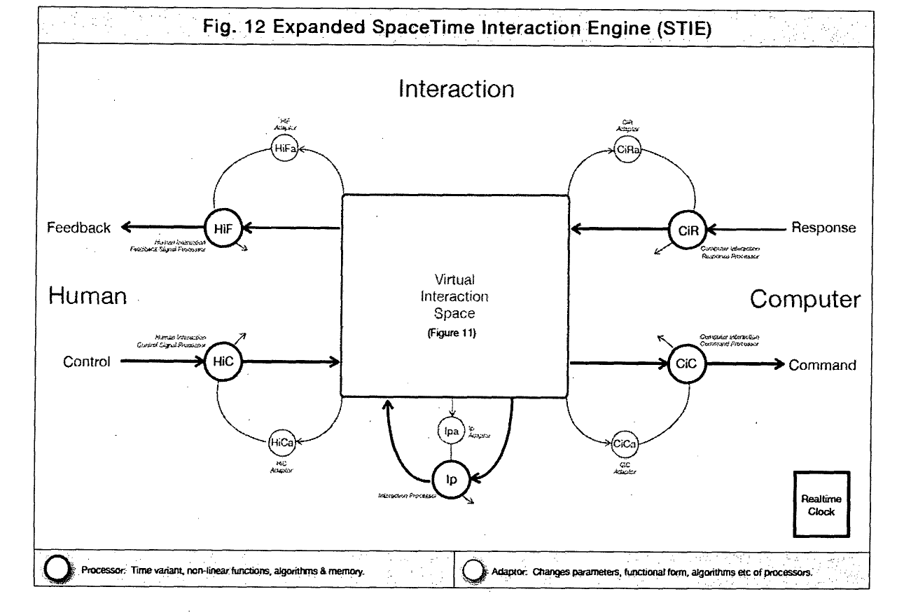

FIG. 12 shows diagrammatically details of the new interaction engine, expanded with more processors and adaptors, according to the invention;

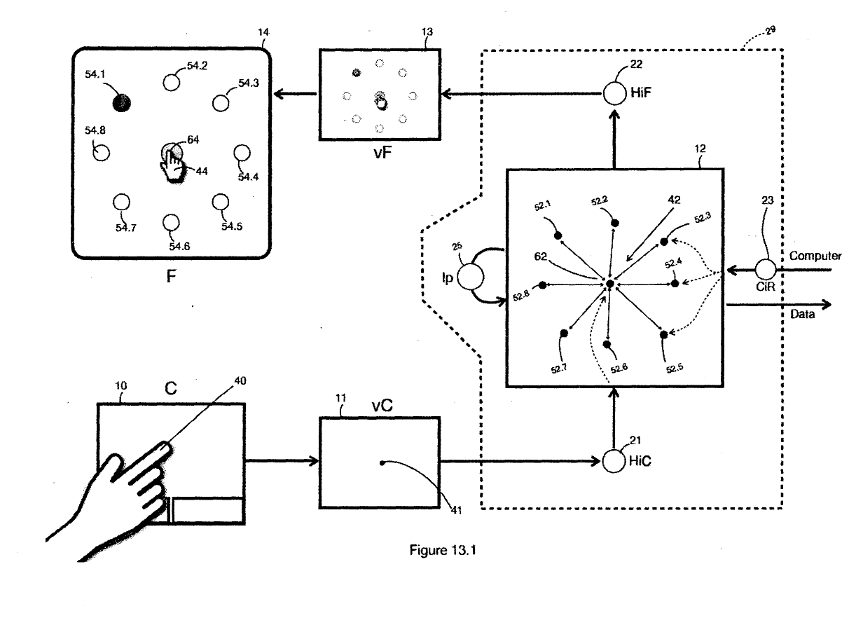

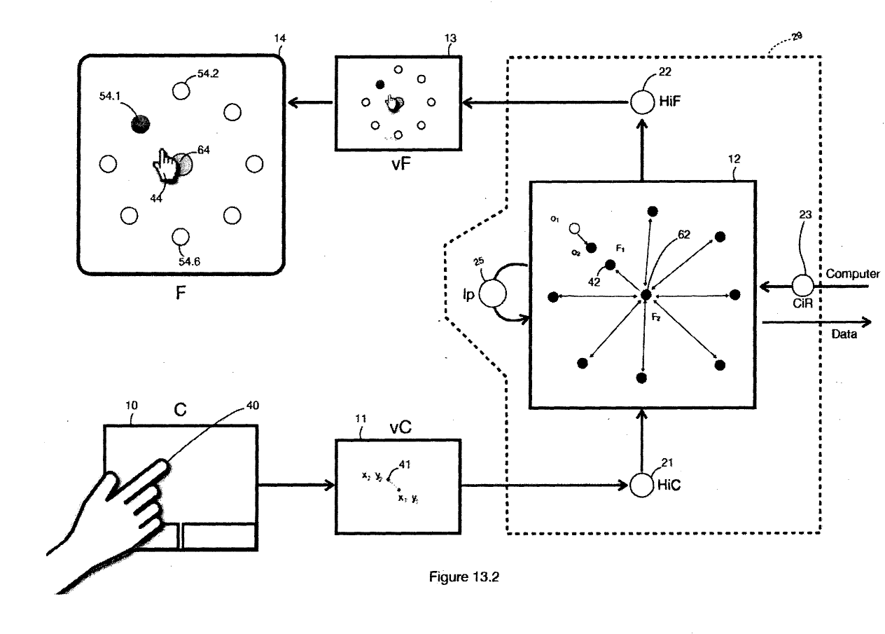

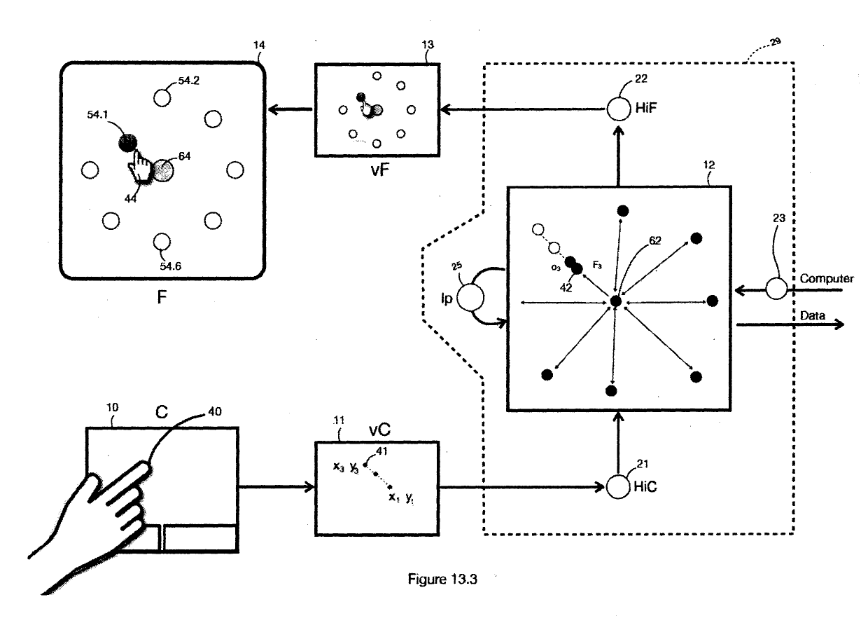

FIGS. 13.1 to 13.3 show diagrammatically a first example of the invention;

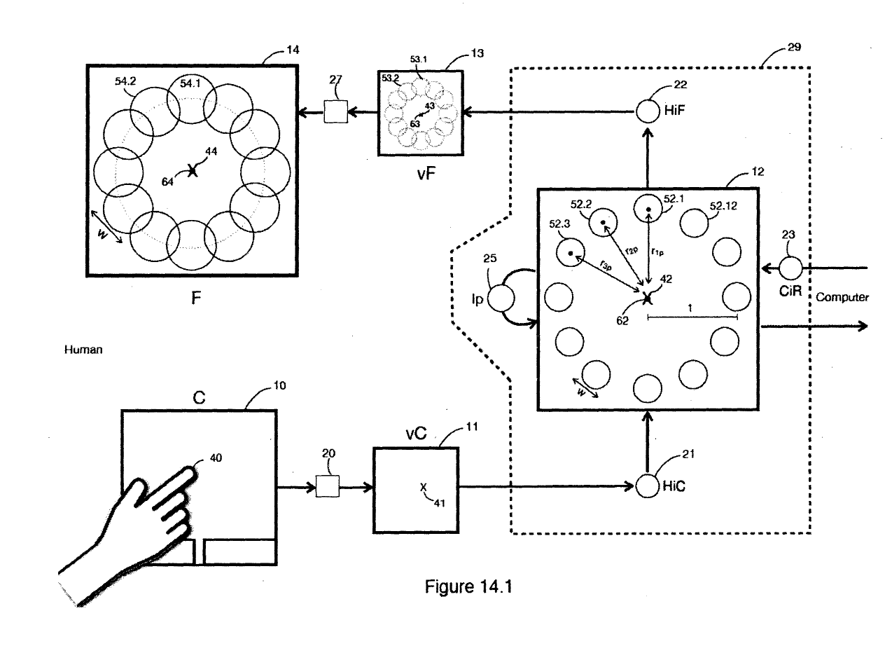

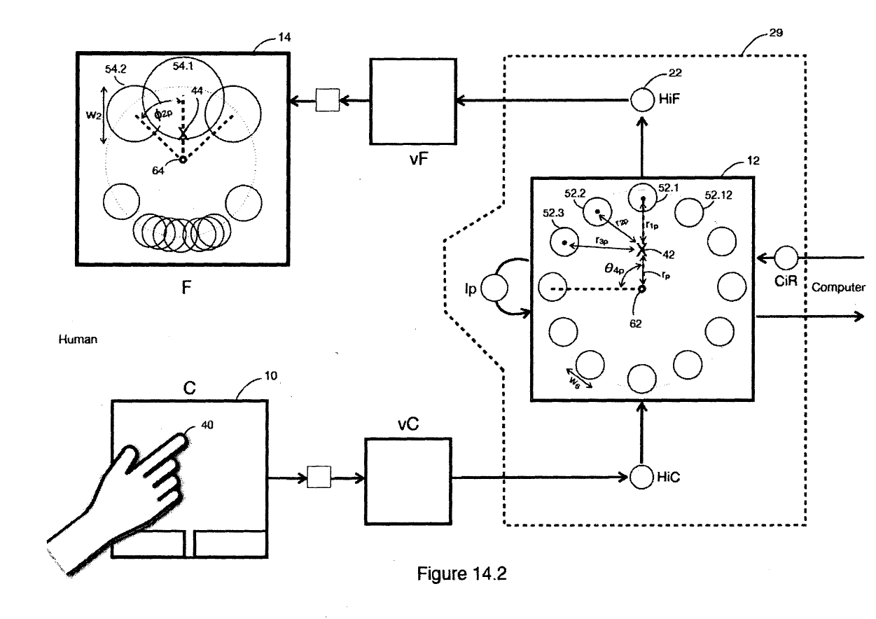

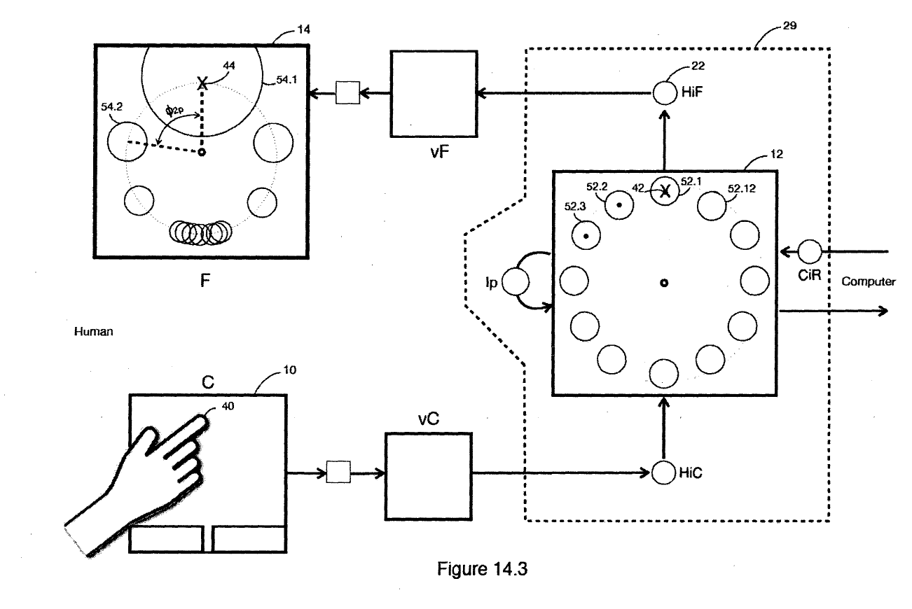

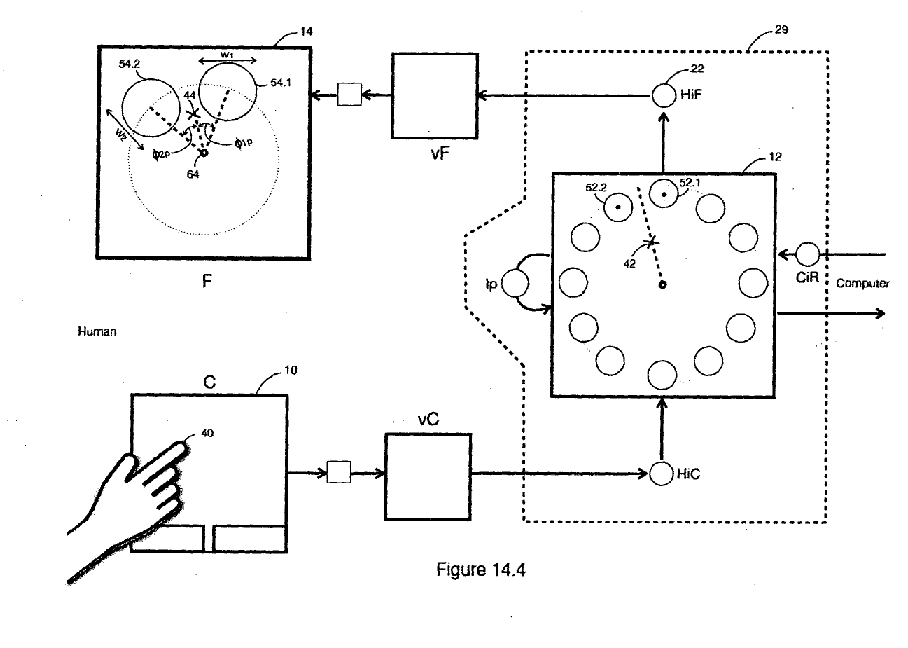

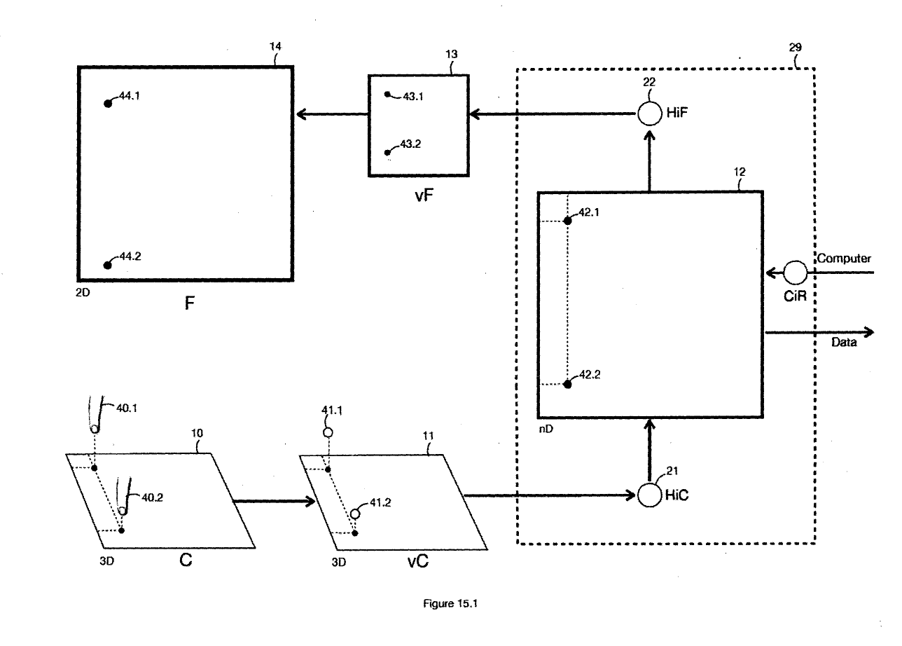

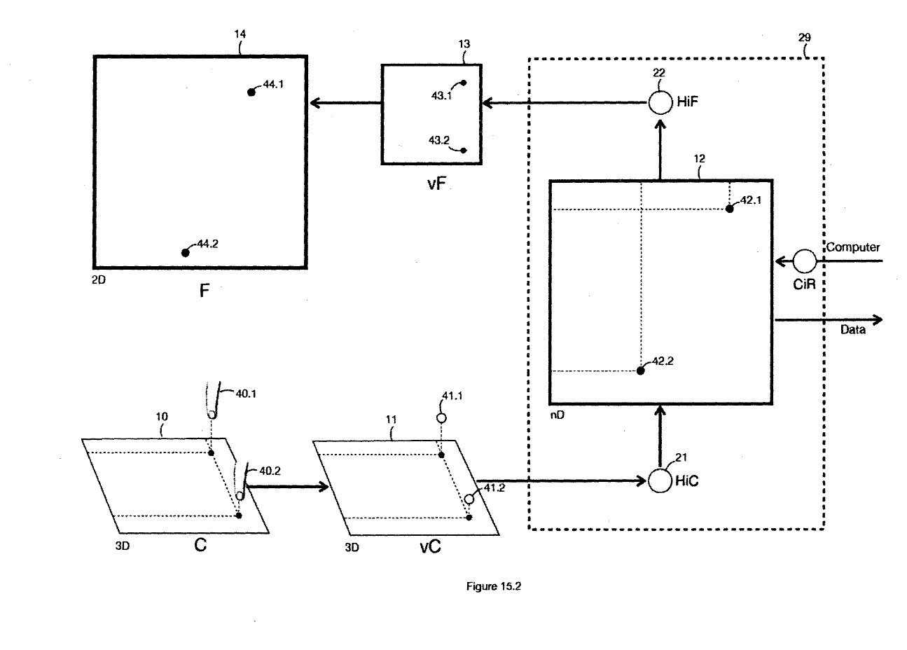

FIGS. 14.1 to 14.4 shows diagrammatically a second example of the invention;

FIGS. 15.1 to 15.2 shows diagrammatically a third example of the invention;

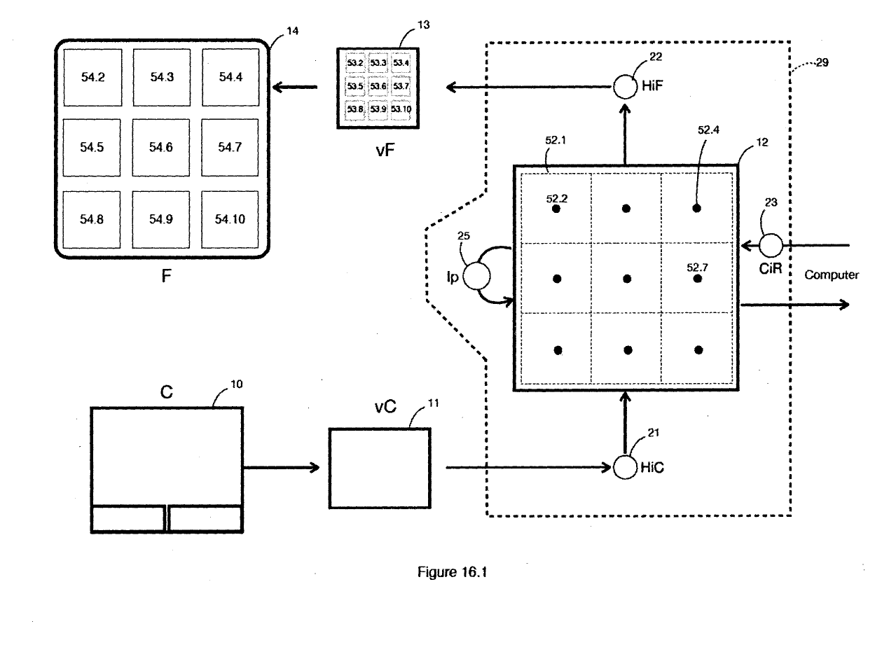

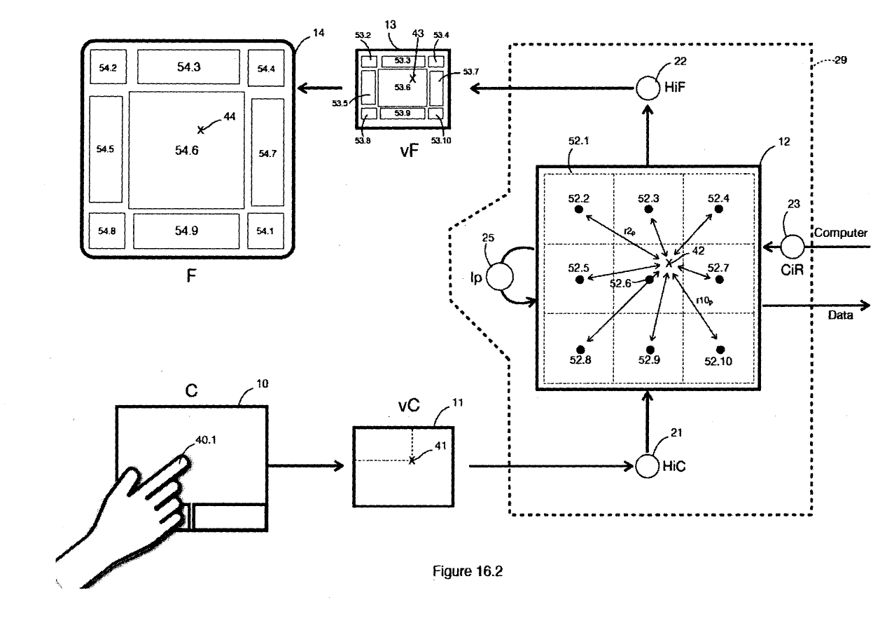

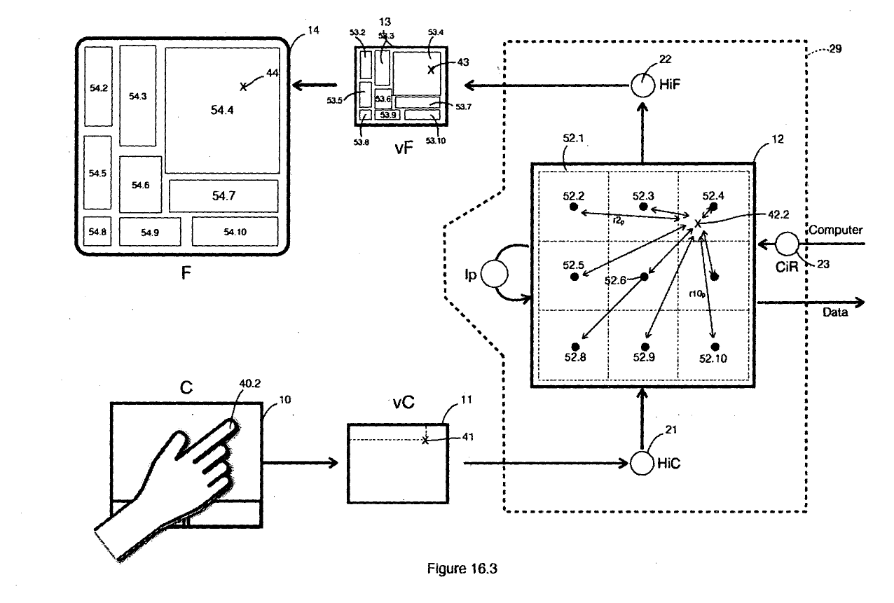

FIGS. 16.1 to 16.3 shows diagrammatically a fourth example of the invention;

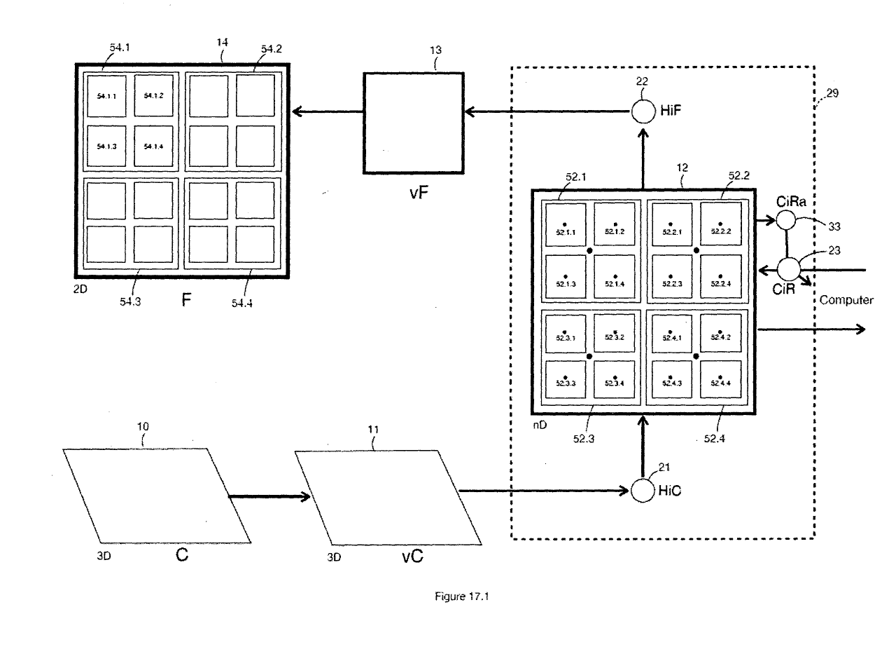

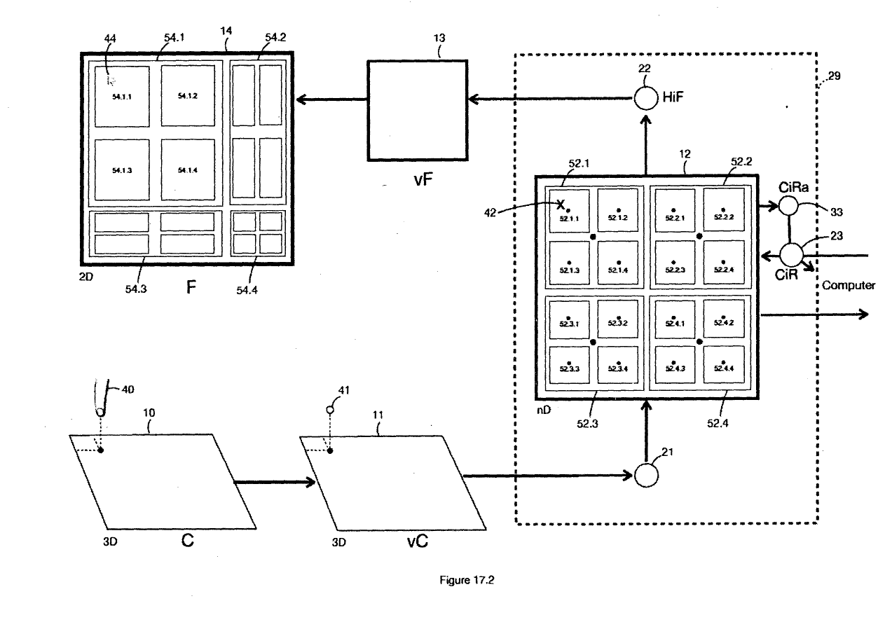

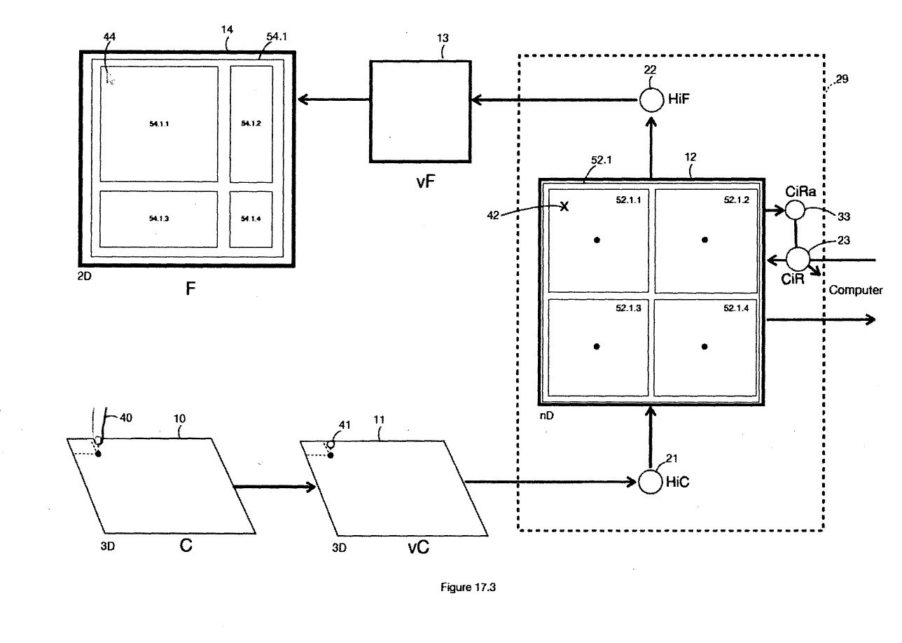

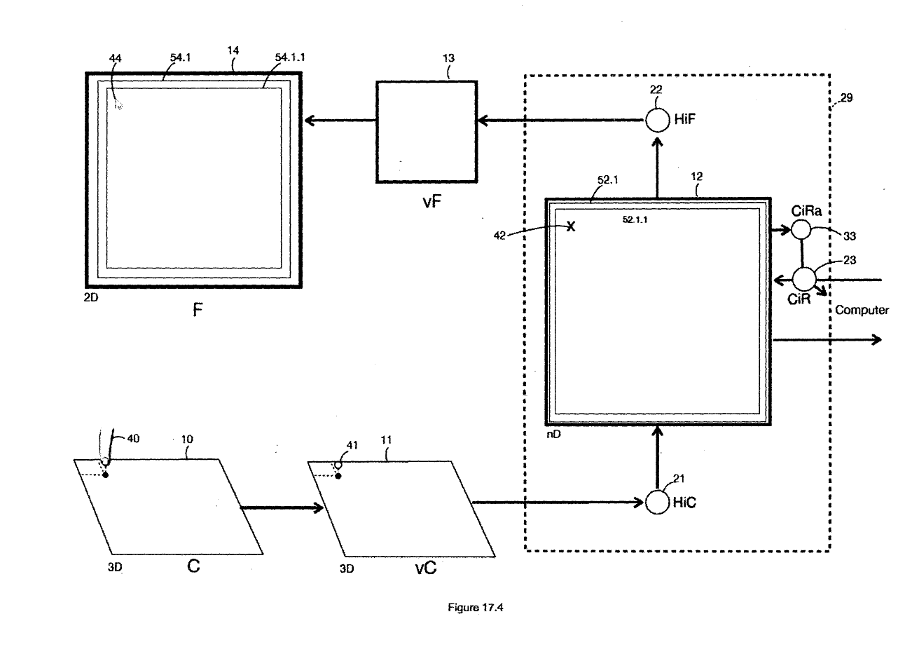

FIGS. 17.1 to 17.4 shows diagrammatically a fifth example of the invention; and

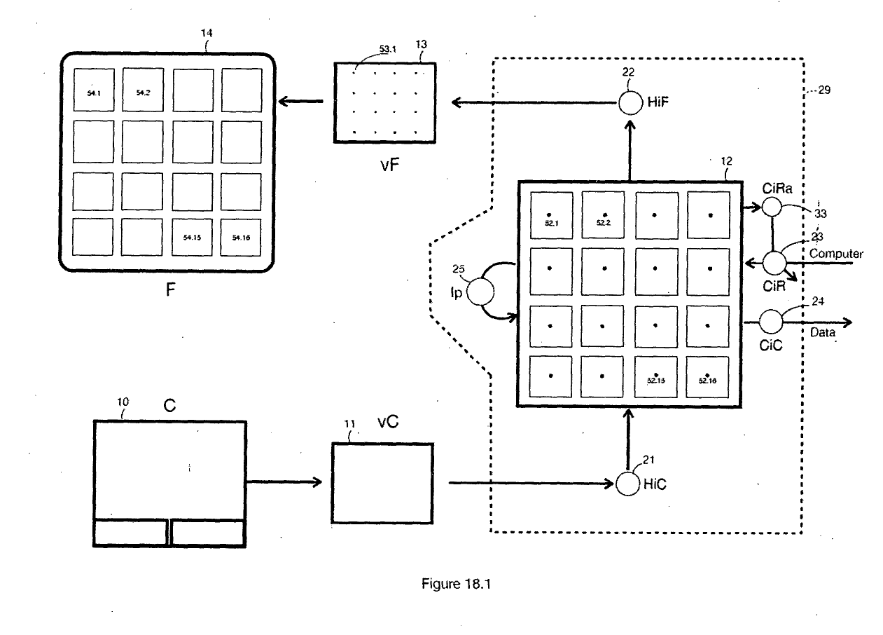

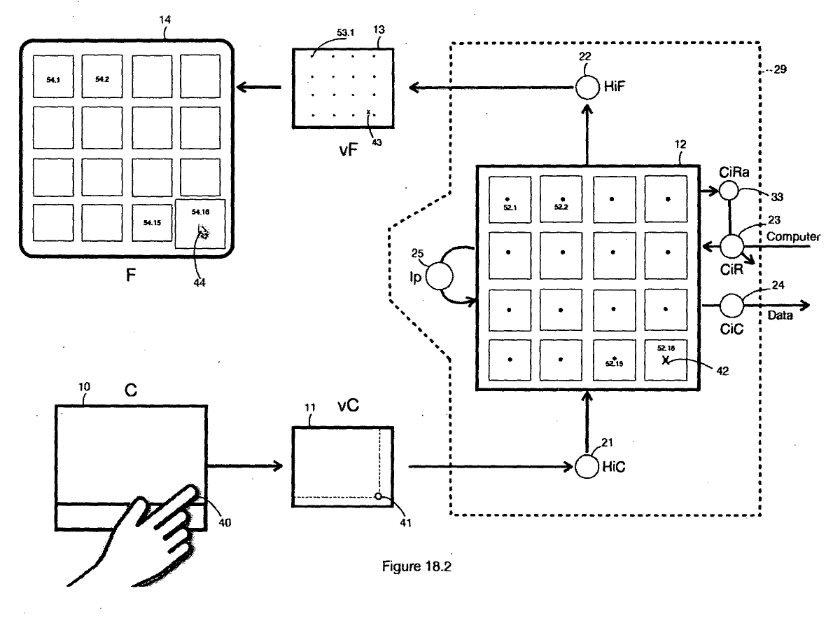

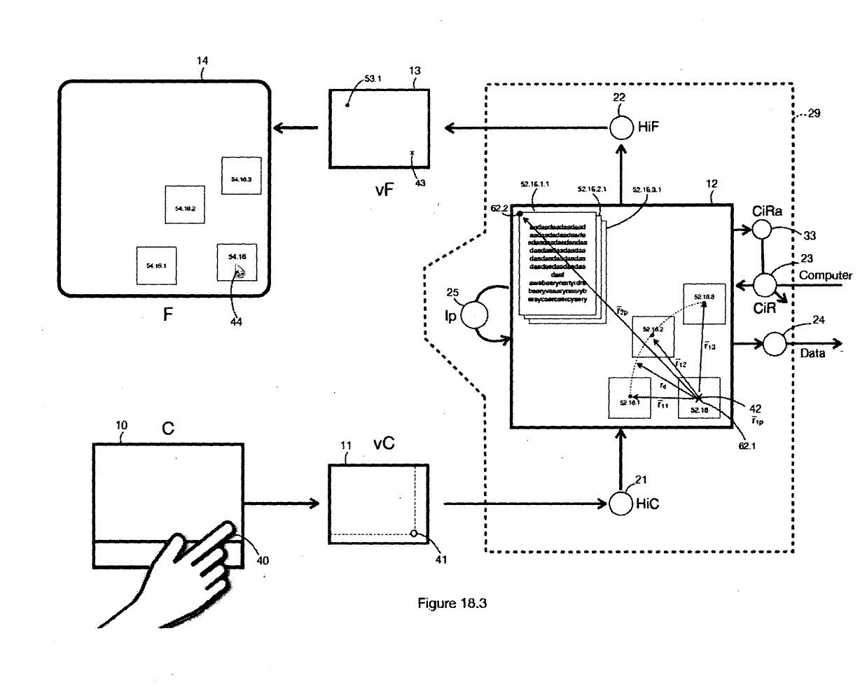

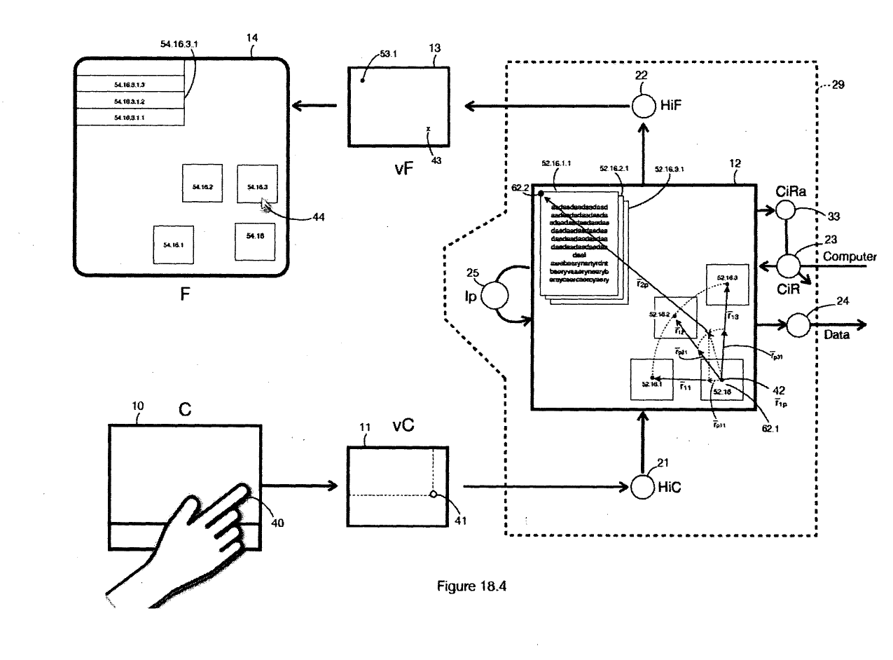

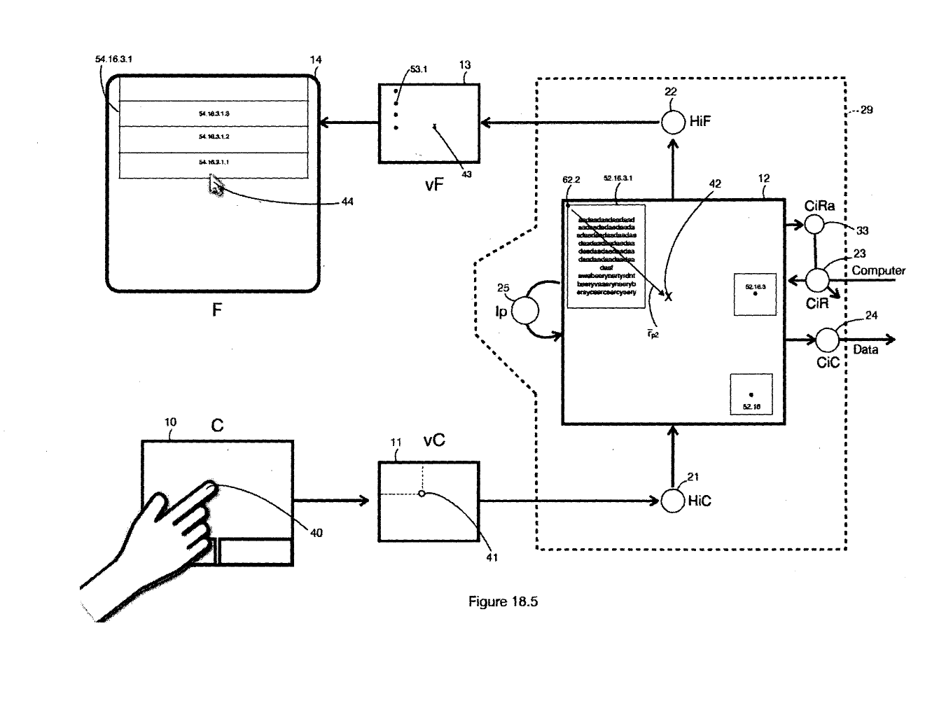

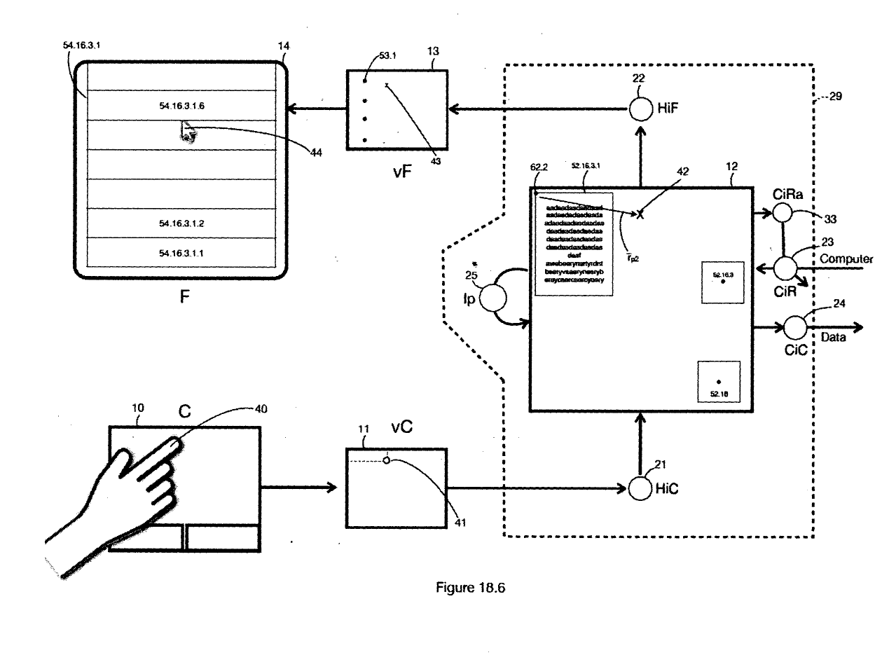

FIGS. 18.1 to 18.6 shows diagrammatically a sixth example of the invention.

Refer to FIG. 9, which shows in context the proposed new interaction engine that is based on a new model of HCI called space-time interaction (STi). In FIG. 9 a virtual Interaction Space (vIS) (see FIG. 11) and various processors are introduced. Together they constitute the Space-time Interaction Engine (STIE), which is detailed in FIG. 10. The importance of space has been emphasized in the foregoing, but time makes an essential contribution to every interaction. This is acknowledged by showing a real-time clock in FIGS. 9 and 10, and in the names chosen for the parts of the model.

According to the invention, a method is provided for human-computer interaction (HCI) on a graphical user interface (GUI), which includes:
tracking the position and/or movement of a user's body or part of it relative to and/or with an input device in a control space;
facilitating human-computer interaction by means of an interaction engine, which includes the steps of
   establishing a virtual interaction space;
   establishing and referencing one or more virtual objects with respect to the interaction space;
   establishing and referencing one or more focal points in the interaction space in relation to the tracked position and/or movement in the control space;
   applying one or more mathematical functions or algorithms to determine the interaction between one or more focal points and the virtual objects in the interaction space, and/or to determine one or more commands to be executed; and
   applying a mathematical function or algorithm to determine what content of the interaction space is to be presented to the user as feedback, and in which way the content is to be displayed; and
providing feedback to the user in a sensory display or feedback space.

According to a further aspect of the invention, an engine is provided for processing human-computer interaction on a GUI, which engine includes:

a means for establishing a virtual interaction space;

a means for establishing and referencing one or more virtual objects with respect to the interaction space;

a means for establishing and referencing one or more focal points in the interaction space in relation to the tracked position and/or movement in the control space;

a means for calculating a mathematical function or algorithm to determine the interaction between one or more focal points and the virtual objects in the interaction space, and/or to determine one or more commands to be executed; and

a means for calculating a mathematical function or algorithm to determine what content of the interaction space is to be presented to the user as feedback, and in which way the content is to be presented.

### Control Space and Control Buffer

FIG. 9 shows the context of both the physical control space (the block labelled “C”) and the control buffer or virtual control space (the block labelled “C buffer”) in the new space-time model for human-computer interaction.

The position and/or movement of a user's body or part of it relative to and/or with an input device is tracked in the physical control space and the tracking may be represented or stored as a real vector function of time in the control buffer as user input data. The sampling rate in time and space of the tracking may preferably be so high that the tracking appears to be continuous.

More than one part of the user's body or input device may be tracked in the physical control space and all the tracks may be stored as user input data in the control buffer.

The user input data may be stored over time in the control buffer.

The tracking may be in one or more dimensions.

An input device may also be configured to provide inputs other than movement. Typically, such an input may be a discrete input, such as a mouse click, for example. These inputs should preferably relate to the virtual objects with which there is interaction and more preferably to virtual objects which are prioritised. Further examples of such an input may be the touch area or pressure of a person's finger on a touch-sensitive pad or screen. Although the term movement is used to describe what is tracked by an input device, it will be understood to also include tracking of indirect movement derived from sound or changes in electrical currents in neurons, as in the case of a Brain Computer Interface.

Virtual Interaction Space (vIS)

FIG. 11 shows a more detailed schematic representation of the virtual interaction space (vIS) and its contents. As shown, the virtual interaction space may be equipped with geometry and a topology. The geometry may preferably be Euclidean and the topology may preferably be the standard topology of Euclidean space.

The virtual interaction space may have more than one dimension.

A coordinate or reference system may be established in the virtual interaction space, comprising a reference point as the origin, an axis for every dimension and a metric to determine distances between points, preferably based on real numbers. More than one such coordinate system can be created.

The objects in the virtual interaction space are virtual data objects and may typically be WIM type objects (window, icon, menu) or other interactive objects. Each object may be referenced at a point in time in terms of a coordinate system, determining its coordinates. Each object may be configured with an identity and a state, the state representing its coordinates, function, behaviour, and other characteristics.

A focal point may be established in the virtual interaction space in relation to the user input data in the control buffer. The focal point may be an object and may be referenced at a point in time in terms of a coordinate system, determining its coordinates. The focal point may be configured with a state, representing its coordinates, function, behaviour, and other characteristics. The focal point state may determine the interaction with the objects in the interaction space. The focal point state may be changed in response to user input data.

More than one focal point may be established and referenced in the virtual interaction space, in which case each focal point may be configured with an identity.

The states of the objects in the virtual interaction space may be changed in response to a change in the state of a focal point and/or object state of other objects in the interaction space.

A scalar or vector field may be defined in the virtual interaction space. The field may, for example, be a force field or a potential field that may contribute to the interaction between objects and focal points in the virtual interaction space.

### Feedback Space and Feedback Buffer

FIG. 9 shows the context of both the physical sensory feedback space (the block labelled “F”) and the feedback buffer, or virtual feedback space (the block labelled “F buffer”) in the new space-time model for human-computer interaction.

An example of a feedback space may be a display device or screen. The content in the virtual interaction space to be observed may be mapped into the display buffer and from there be mapped to the physical display device.

The display device may be configured to display feedback in three dimensions.

Another example of a feedback space may be a sound reproduction system.

### Processors

The computer may be configured with one or more physical processors, whose processing power may be used to run many processes, either simultaneously in a parallel processing setup, or sequentially in a time-slice setup. An operating system schedules processing power in such a way that processes appear to run concurrently in both these cases, according to some scheme of priority. When reference is made to processor in the following, it may include a virtual processor, whose function is performed either by some dedicated physical processor, or by a physical processor shared in the way described above.

FIG. 10 shows the Space-time interaction engine for example, containing a number of processors, which may be virtual processors, and which are discussed below.

### HiC Processor—Human Interaction Control Processor and Control Functions

The step of establishing and referencing one or more focal points in the interaction space in relation to the tracked position and/or movement in the control space may be effected by a processor that executes one or more Control functions or algorithms, named a Human interaction Control or HiC processor.

The HiC processor may take user input data from the virtual control space to give effect to the reference of the focal point in the interaction space. The HiC processor may further be configured to also use other inputs such as a discrete input, a mouse click for example, which can also be used as a variable by a function to interact with objects in the interaction space or to change the characteristics of the focal point.

Ip Processor—Interaction Processor and Interaction Functions

The function or functions and/or algorithms which determine the interaction of the focal point and objects in the interaction space, and possibly the effect of a field in the interaction space on the objects, will be called Interaction functions and may be executed by an Interaction processor or Ip processor.

One or more Interaction functions or algorithms may include interaction between objects in the interaction space. In the case of more than one focal point, there may also be an interaction between the focal points. It will be appreciated that the interaction may preferably be bi-directional, i.e. the focal point may interact with an object and the object may interact with the focal point.

The interaction between the focal point and the objects in the interaction space may preferably be nonlinear.

The mathematical function or algorithm that determines the interaction between the focal point and the objects in the interaction space, may be configured for navigation between objects to allow navigation through the space between objects. In this case, the interaction between the focal point and objects relates to spatial interaction.

In an embodiment where the interaction function is specified so that objects in the interaction space change their state or status in relation to a relative position of a focal point, an object in the form of an icon may transform to a window and vice versa, for example, in relation to a focal point, whereas in the known GUI these objects are distinct until the object is aligned with the pointer and clicked. This embodiment will be useful for navigation to an object and to determine actions to be performed on the object during navigation to that object.

The mathematical function or algorithm which determines the interaction between the focal point and the objects in the interaction space may be specified so that the interaction of the focal point with the objects is in the form of interacting with all the objects or a predetermined collection of objects according to a degree of selection and/or a degree of interaction. The degree of selection or interaction may, for example, be in relation to the relative distance of the focal point to each of the objects in the interaction space. The degree of selection may preferably be in terms of a number between 0 and 1. The inventors wish to call this Fuzzy Selection.

HIF Processor—Human Interaction Feedback Processor and Feedback Functions

The mathematical function or algorithm to determine the content of the interaction space to be observed is called the Feedback function and may be executed by the Human interaction Feedback or HiF processor.

The Feedback function may be adapted to map or convert the contents to be displayed in a virtual display space or display buffer in which the coordinates are integers. There may be a one-to-one mapping of bits in the display buffer and the pixels on the physical display.

The Feedback function may also be adapted to include a scaling function to determine the number of objects or the collection of objects in the interaction space to be displayed. The scaling function may be user configurable.

It will be appreciated that the Feedback function is, in effect, an output function or algorithm and the function or algorithm may be configured to also effect outputs other than visual outputs, such as sound, vibrations and the like.

### CiR Processor—Computer Interaction Response Processor and Response Functions

A mathematical function or algorithm which determines the selection and use of data stored in memory to establish and compose the virtual interaction space and/or objects in it can be called the Response function and may be executed by the Computer interaction Response or CiR processor.

### CiC Processor—Computer Interaction Command Processor and Command Functions

A mathematical function or algorithm that determines the data to be stored in memory and/or the commands to be executed, can be called the Command function and may be executed by the Computer interaction Command or CiC processor.

### Adaptors

An adaptor will be understood to mean a processor configured to change or affect any one or more of the parameters, functional form, algorithms, application domain, etc. of another processor, thereby dynamically redefining the functioning of the other processor.

### HiC Adaptor (HiCa)

One adaptor, which will be called the Human interaction Control adaptor (HiCa), uses information from the virtual interaction space (vIS) to dynamically redefine the functioning of the HiC processor. The HiCa represents a form of feedback inside the interaction engine.

The HiCa may change the Control function to determine or define the position, size or functionality of the control space in relation to the position of the focal point in the interaction space and/or in relation to the position or dimensions of objects in the interaction space. The determination or definition of the control space may be continuous or discrete.

### CiR Adaptor (CiRa)

Another adaptor, which will be called the Computer interaction Response adaptor (CiRa) uses information from the virtual interaction space (vIS) to dynamically redefine the functioning of the CiR processor. The CiRa is a feedback type processor.

### HiF Adaptor (HiFa)

Another adaptor, shown in the expanded engine of FIG. 12, which will be called the Human interaction Feedback adaptor (HiFa), uses information from the virtual interaction space (vIS) to dynamically redefine the functioning of the HiF processor. The HiFa is a feed-forward type processor.

### CiC Adaptor (CiCa)

Another adaptor, which will be called the Computer interaction Command adaptor (CiCa) uses information from the virtual interaction space (vIS) to dynamically redefine the functioning of the CiC processor. The CiCa is a feed-forward type processor.

### Ip Adaptor (Ipa)

Another adaptor, which will be called the Interaction Processor adaptor (Ipa) uses information from the virtual interaction space (vIS) to dynamically redefine the functioning of the Ip processor. The Ipa is a feed-forward type processor.

It will be appreciated that the separation of the interaction space and the feedback or display space creates the possibility for the addition of at least one interaction processor (HiF) and one adaptor (HiFa), which was not possible in the classic GUI as shown in FIG. 7.

It will be appreciated that, although treated separately, there will often be some conceptual overlap between the interaction space and the display space. It will further be appreciated that referencing the WIM objects in their own space allows for the addition of any one of a number of customised functions or algorithms to be used to determine the interaction of the pointer in the visual space with WIM objects in the interaction space, whether in the visual space or not. The interaction can also be remote and there is no longer a need to align a pointer with a WIM object to interact with that object.

Since the buffer memory of a computer is shared and holds data for more than one application or process at any one time, and since the processor of a computer is normally shared for more than one application or process, it should be appreciated that the idea of creating spaces within a computer is conceptual and not necessarily physical. For example, space separation can be conceptually achieved by assigning two separate coordinates or positions to each object; an interaction position and a display position. Typically one would be a stationary reverence coordinate or position and the other would be a dynamic coordinate that changes according to the interaction of the focal point or pointer with each object. Both coordinates may be of a typical Feedback buffer format and the mathematical function or algorithm that determines the interaction between the focal point or pointer and the objects may use the coordinates from there. Similarly, the focal point may be provided with two coordinates, which may be in a Control buffer format or a Feedback buffer format. In other words, there may be an overlap between the Virtual Interaction Space, Control buffer or space and Feedback buffer or space, which can conceptually be separated. It will also be understood that, if an interaction position is defined for an object in virtual and/or display space, it may or may not offset the appearance of the object on the computer screen.

The method may include providing for the virtual interaction and display spaces to overlap in the way described above, and the step of establishing two separate states for every object, namely an interaction state and a display state. These object states may include the object position, sizes, colours and other attributes.

The method may include providing for the virtual interaction and virtual display spaces to overlap and thereby establishing a separate display position for each object based on interaction with a focal point or tracked pointer. The display position can also be established based on interaction between a dynamic focal point and a static reference focal point.

The method may include providing for the virtual interaction and virtual display spaces to overlap and to use the relative distances between objects and one or more focal points to establish object positions and/or states. This method may include the use of time derivatives.

One embodiment may include applying one or more mathematical functions or algorithms to determine distant interaction between a focal point and the virtual objects in the interaction space, which interaction at/from a distance may include absence of contact, for example between the focal point and any object with which it is interacting.

In one embodiment, the method may include a non-isomorphic function or algorithm that determines the mapping of object positions from virtual interaction space to display space. Mapping in this context is taken to be the calculation of the display position coordinates based on the known interaction position coordinates.

In one embodiment, the method may include a non-isomorphic function or algorithm that uses focal point positions and object point positions to determine the mapping of object sizes from virtual interaction space to display space.

In one embodiment, the method may include a non-isomorphic function or algorithm that determines the mapping of object positions and sizes from virtual interaction space to display space.

In one embodiment, the method may include a non-isomorphic function or algorithm that determines the mapping of object state from virtual interaction space to display space.

The method may include a non-isomorphic function or algorithm that uses a focal point position and object positions in virtual interaction space to update object positions in the virtual interaction space.

The method may include a non-isomorphic function or algorithm that uses a focal point position and object positions in virtual interaction space to update object sizes in the virtual interaction space.

The method may include a non-isomorphic function or algorithm that uses a focal point position and object positions in virtual interaction space to update object positions and sizes in the virtual interaction space.

The method may include a non-isomorphic function or algorithm that uses a focal point position and object positions in virtual interaction space to update object states in the virtual interaction space.

The method may include a non-isomorphic function or algorithm that uses a focal point position and object positions to determine the mapping of object positions from virtual interaction space to display space as well as to update object positions in the virtual interaction space.

The method may include a non-isomorphic function or algorithm that determines the mapping of object sizes from virtual interaction space to display space.

The method may include a non-isomorphic function or algorithm that determines the mapping of object positions and sizes from virtual interaction space to display space.

The method may include a non-isomorphic function or algorithm that determines the mapping of object state from virtual interaction space to display space.

The method may include using the position of a focal point in relation to the position of the boundary of one or more objects in the virtual interaction space to effect crossing-based interaction. An example of this may be where object selection is automatically effected by the system when the focal point crosses the boundary of the object, instead of requiring the user to perform, for example, a mouse click for selection.

The method may include the calculation and use of time derivatives of the user input data in the control buffer to create augmented user input data.

The method may include dynamically changing the state of objects in the virtual interaction space, based on the augmented user input data.

The method may include dynamically changing the properties of the scalar and/or vector fields in the virtual interaction space, based on the augmented user input data.

The method may include dynamically changing the properties of the scalar and/or vector fields in the virtual interaction space, based on the position and/or state of one or more objects in the virtual interaction space.

The method may include dynamically changing the properties of the scalar and/or vector fields in the virtual interaction space, based on data received from or via the part of the computer beyond the interface.

The method may include dynamically changing the geometry and/or topology of the virtual interaction space itself, based on the augmented user input data.

The method may include dynamically changing the geometry and/or topology of the virtual interaction space itself, based on the position and/or properties of one or more objects in the virtual interaction space.

The method may include dynamically changing the geometry and/or topology of the virtual interaction space itself, based on data received from or via the computer.

The method may include interaction in the virtual interaction space between the focal point or focal points and more than one of the objects simultaneously.

The method may include the step of utilizing a polar coordinate system in such a way that the angular coordinate of the focal point affects navigation and the radial coordinate affects selection.

The method may include the step of utilizing any pair of orthogonal coordinates of the focal point to determine whether the user intends to navigate or to perform selection. For example, the vertical Cartesian coordinate may be used for navigation and the horizontal coordinate for selection.

The method may preferably use the HiC processor to apply the Control function or algorithm. This may include the non-isomorphic mapping augmented user input from the control buffer to the virtual interaction space.

The method may preferably use the HiF processor to apply the Feedback function or algorithm. This may include the non-isomorphic mapping of relative object positions from virtual interaction space to display space.

The method may preferably use the CiR processor to apply the Response function or algorithm. This may include the establishment of relative object positions in virtual interaction space.

The method may preferably use the CiC processor to apply the Command function or algorithm. This may include a command to play a song, for example.

The method may preferably use the Ip processor to apply the Interaction function or algorithm. This may include using the state of an object in virtual interaction space to change the state of another object or objects in the virtual interaction space.

The method may preferably use the HiCa to adapt the functioning of the HiC processor. This may include the HiCa execution of a function or algorithm to adapt the free parameters of a Control function.

The method may preferably use the HiFa to adapt the functioning of the HiF processor. This may include the HiFa execution of a function or an algorithm to adapt the free parameters of a Feedback function.

The method may use the CiRa to adapt the functioning of the CiR processor. This may include the CiRa execution of a function or an algorithm that determines which objects to insert in virtual interaction space.

The method may use the CiCa to adapt the functioning of the CiC processor. This may include the CiCa execution of a function or an algorithm to adapt the free parameters of a Command function.

The method may use the Ipa to adapt the functioning of the Ip processor. This may include the Ipa execution of a function or algorithm to adapt the free parameters of an Interaction function.

In a preferred embodiment, the method may use one or more in any combination of the HiC processor, CiC processor, CiR processor, Ip processor, HiF processor, HiCa, CiCa, CiRa, Ipa and/or HiFa to facilitate continuous human-computer interaction.

The method may include a Feedback function or algorithm that uses the spatial relations between one or more focal points and the objects in virtual interaction space to establish a different spatial relation between objects in display space.

The method may include a further Feedback function or algorithm that uses the spatial relations between one or more focal points and the objects in virtual interaction space to establish different state values for each object in display space.

The method may include an Interaction function or algorithm that uses the spatial relations between one or more focal points and the objects in virtual interaction space to establish a different spatial relation between objects in virtual interaction space.

The method may include an Interaction function or algorithm that uses the spatial relations between one or more focal points and the objects in virtual interaction space to establish different state values for each object in virtual interaction space.

The method may include allowing or controlling the relative position of some or all of the objects in the virtual interaction space to have a similar relative position in the display space when the focal point or focal object has the same relative distance distribution between all the objects. A further method may include allowing or controlling the relative positions of some or all of the objects to change in relation to the relative positions when comparing the interaction and the display space in such a way that the change in relative position of the focal point or focal object is a function of the said change. The relative object positions may differ in the display space when compared with their relevant positions in the interaction space.

The method may include allowing or controlling the relative size of some or all of the objects in the vIS to have a similar size in the display space when the focal point or focal object has the same relative distance distribution between all the objects. A further method may include allowing or controlling the relative size of some or all of the objects to change in relation to the relative sizes when comparing the interaction and the display space in such a way that the change in relative position of the focal point or focal object is a function of the said change. The relative object size may differ in the display space when compared with its relevant positions in the interaction space.

The method may include allowing or controlling the relative position and size of some or all of the objects in the vIS to have a similar relative position and size in the display space when the focal point or focal object has the same relative distance distribution between all the objects. A further method may include allowing or controlling the relative positions and sizes of some or all of the objects to change in relation to the relative positions when comparing the interaction and the display space in such a way that the change in relative position of the focal point or focal object is a function of the said change. The relative object positions and sizes may differ in the display space when compared with their relevant positions in the interaction space.

The interaction of the focal point in the control space with objects in the interaction space occurs non-linearly, continuously and dynamically according to an algorithm of which the focal point position in its control space is a function.

### DETAILED DESCRIPTION OF THE INVENTION

It shall be understood that the examples are provided for illustrating the invention further and to assist a person skilled in the art with understanding the invention and are not meant to be construed as unduly limiting the reasonable scope of the invention.

### Example 1

In a first, most simplified, example of the invention, as shown in FIGS. 13.1 to 13.3, the method for human-computer interaction (HCI) on a graphic user interface (GUI) includes the step of tracking movement of pointing object, a person's finger 40 in this case, on a touch sensitive pad 10, the control space. Human-computer interaction is facilitated by means of an interaction engine 29, which establishes a virtual interaction space 12 and referencing 8 objects 52 in a the space. A CiR processor 23 determines the objects to be composed the virtual interaction space 12. The interaction engine 29 further establishes and references a focal point 42 in the interaction space 12 in relation to the tracked movement of the person's finger 40 and reference point 62. The engine 29 then uses the Ip processor 25 to determine the interaction of the focal point 42 in the interaction space 12 and objects 52 in the interaction space. In terms of the algorithm, the object, 52.1 in this case, closest to the focal point at any point in time will move closer to the focal point and the rest of the objects will remain stationary. The HiF processor 22 determines the content of the interaction space 12 to be observed by a user and the content is isomorphically mapped and displayed on the visual display feedback buffer 14. In the display 14, the reference point is represented by the dot marked 64. The person's finger 40 in the control space 10 is represented by a pointer 44. The objects are represented by 54.1 to 54.8. The tracking of the person's finger is repeated within short intervals and appear to be continuous. The tracked input device or pointer object input data is stored over time in the virtual control space or control buffer.

### Example 2

In another example of the invention, with reference to FIGS. 14.1 to 14.4, the method for human-computer interaction (HCI) on a graphical user interface (GUI) includes the step of tracking the movement of a pointing object, a person's finger 40 in this case, on a touch sensitive pad 10, in the control space (C). The tracked pointing object input data (coordinates or changes in coordinates) 41 is stored over time in the virtual control (vC), space or control buffer 11, after being mapped isomorphically by processor 20. Reference point 62 is established by the CiR processor 23 inside the virtual interaction space 12. The CiR processor 23 further assigns regularly spaced positions rᵢ on a circle of radius one centred on the reference point 62, and uniform sizes wᵢ to the circular virtual objects 52.i in virtual interaction space 12, where i may throughout this example range from 1 to N. The HiC processor 21 establishes a focal point 42 and calculates, and continually updates, its position in relation to the reference point 62, using a function or algorithm based on the input data 41. The Ip processor 25 calculates the distance rₚ between the focal point 42 and the reference point 62, as well as the relative distances rᵢₚ between all virtual objects 52.i and the focal point 42, based on the geometry and topology of the virtual interaction space 12, and updates these values whenever the position of the focal point 42 changes. The HiF processor 22 establishes a reference point 63, a virtual pointer 43 and virtual objects 53.i in the feedback buffer 13, and calculates and continually updates the positions and sizes of virtual objects 63, 43 and 53.i, using a function or algorithm based on the relative distances rᵢₚ in virtual interaction space 12 as calculated by the Ip processor 25. Processor 27 establishes and continually updates a reference point 64, a pointer 44 and pixel objects 54.i in the feedback space, a display device 14 in this case, isomorphically mapping from 63, 43 and 53.i respectively.

FIG. 14.1 shows the finger 40 in a neutral position in control space 10, which is the position mapped by the combined effect of processors 20 and 21 to the reference point 62 in the virtual interaction space 12, where the focal point 42 and reference point 62 therefore coincide for this case. The relative distances rᵢₚ between the N=12 virtual objects 52.i and the focal point 42 are all equal to one. The combined effect of processors 22 and 27 therefore in this case preserves the equal sizes and the symmetry of object placement in the mapping from the virtual interaction space 12 to the feedback or display space 14, where all circles have the same diameter W.

With displacement of the finger 40 in control space 10 to a new position, FIG. 14.2 shows the focal point 42 mapped halfway between the reference point 62 and the virtual object 52.1 in the virtual interaction space 12. Note that the positions of the virtual objects 52.i never change in this example. The relative distance rᵢₚ with respect to the focal point 42 is different for every virtual object 52.i however, and the mapping by the HiF processor 22 yields different sizes and shifted positions for the objects 54.i in the feedback or display space 14. The function used for calculating display size is

$${W}_{i} = \frac{mW}{1 + ( m - 1 ) {r}_{ip}^{q}}$$

where m is a free parameter determining the maximum magnification and q is a free parameter determining how strongly magnification depends upon the relative distance. The function family used for calculating relative angular positions may be sigmoidal, as follows: θᵢₚ is the relative angular position of virtual object 52.i with respect to the line connecting the reference point 62 to the focal point 42 in the virtual interaction space 12. The relative angular position is normalised to a value between −1 and 1 by calculating

$${u}_{ip} = \frac{{θ}_{ip}}{π} .$$

Next, the value of vᵢₚ is determined as a function of uᵢₚ and rₚ, using a piecewise function based on ue^{u} for 0≦u<1/N, a straight line for 1/N≦u<2/N and 1−e^{-u} for 2/N≦u≦1, with rₚ as a parameter indexing the strength of the non-linearity. The relative angular position φᵢₚ of pixel object 54.i with respect to the line connecting the reference point 64 to the pointer 44 in display space 14, is then calculated as φᵢₚ=π□vᵢₚ. The resultant object sizes and placements are shown in FIG. 14.2.

On displacement of the finger 40 in control space 10 to a new position that is mapped as described above to a focal point 42 in virtual interaction space 12 that coincides with the position in this case of virtual object 52.1, the functions implemented by the HiF processor 22 described above lead to the arrangement of objects 54.i in display space 14 shown in FIG. 14.3.

On displacement of the finger 40 in control space 10 to a new position that is mapped as described above to a focal point 42 in virtual interaction space 12 that in this case lies a distance halfway from the reference point 62 and halfway between the positions of virtual objects 52.1 and 52.2, the functions implemented by HiF processor 22 described above lead to the arrangement of objects 54.i in display space 14 shown in FIG. 14.4, where W₁=W₂ and φ₁ₚ=φ_{2p.}

The display of reference point 64 and pointer 44 may be suppressed, a change which can be effected by changing the mapping applied by the HiF processor 22 to make them invisible.

If chosen correctly, the functions or algorithms implemented by the HiC processor 21 and the HiF processor 22 may be sufficient to completely and uniquely determine the configurations of the pixel objects 54.i in display space 14 for any position of the person's finger 40 in the control space 10. The tracking of the person's finger 40 is repeated within short intervals of time and the sizes and positions of pixel objects 54.i appear to change continuously due to image retention on the human retina. If the necessary calculations are completed in real time, the person has the experience of continuously and simultaneously controlling all the displayed objects 54.i by moving his finger 40.

### Example 3

For this example, reference is made to FIGS. 15.1 to 15.3. The controller (C), is in the form of a three-dimensional multi-touch (3D-MT) input device. The 3D-MT device provides the position of multiple pointing objects (such as fingers) as a set of 3D coordinates (projected positions) in the touch (x-y) plane, along with the height of the objects (z) above the touch plane. The method for human-computer interaction (HCI) on a graphical user interface (GUI) includes the step of tracking the movement of multiple pointer objects 40.i, in the form of a person's fingers, where i can be 1 to N, on or over a three-dimensional multi-touch (3D-MT) input device (C) 10. After being isomorphically mapped as in the previous example, the tracked pointer input data (3D coordinates or change in coordinates) 41.i are stored over time in the virtual control space (vC) 11. The HiC processor 21 establishes a focal point 42.i for each pointer object in the virtual interaction space (VIS) 12 as a function of each pointer's previous position, its current position, so that objects that move the same distance over 11 and 12's x-y plane, but at different heights (different z coordinate values) above the touch plane, result in different distances moved for each 42.i in VIS 12. The HiF processor 22 establishes for each focal point 42.i a virtual pointer 43.i in the virtual feedback buffer (vF) 13 using isomorphic mapping. Each virtual pointer 43.i is again mapped isomorphically to a visual pointer 44.i in the feedback space (F) 14.

The following dynamic, self-adaptive infinite impulse response (IIR) filter is used in the HIC processor 21:

\vec{Q}(n)=\vec{Q}(n−1)+ƒ(z)·[\vec{P}(n)−\vec{P}(n−1)], (Equation 103.1)

where \vec{P}(n) is a vector containing the x and y coordinate values of a pointer in the virtual control buffer 12 at time step n, \vec{Q}(n) is a vector containing the x and y coordinate values of a focal point in the VIS 12 at time step n, ƒ(z) is a continuous function of z that determines a scaling factor for the current sample and Z is the current coordinate value of a the pointer in vC 11. Equation 103.1 is initialised, so that, at time step n=0, \vec{Q}(n−1)=\vec{Q}(n) and \vec{P}(n−1)=P(n). There are numerous possible embodiments of ƒ(z), e.g.:

ƒ(z)=1, (Equation 103.2)

which embodies unity scaling;

$$f ( z ) = \{ \begin{matrix}0.5 , & 0 < z < {z}_{a} \\ 2 , & {z}_{a} \leq z < {z}_{b} \\ 1 , & z \geq {z}_{b}\end{matrix} , \qquad ( Equation 103.3 )$$

where zₐ and z_{b} are constants and zₐ<z_{b}; and

$$f ( z ) = \{ \begin{matrix}\frac{1.5 \cdot z}{{z}_{a}} + 0.5 , & 0 < z < {z}_{a} \\ \frac{z - {z}_{b}}{( {z}_{a} - {z}_{b} )} + 1 , & {z}_{a} \leq z < {z}_{b} \\ 1 , & z \geq {z}_{b}\end{matrix} , \qquad ( Equation 103.4 )$$

where zₐ and z_{b} are constants and zₐ<z_{b.}

FIG. 15.1 shows two pointer objects, in this case fingers 40.1 and 40.2, in an initial position, so that the height z_{40.1} of pointer object 40.1 is higher above the touch plane of 10 than the height z_{40.2} of pointer object 40.2, i.e. z_{40.1}>z_{40.2}. The pointer objects are isomorphically mapped to establish pointers 41.1 and 41.2. The pointers are mapped by the HiC 21 processor, using in this case Equation 103.3 as the scaling function in Equation 103.1 and with z_{40.1}>z_{b} and z_{40.1}<zₐ, to establish focal points 42.1 and 42.2 in 12. The focal points are mapped by HiF 22 to establish virtual pointers 43.1 and 43.2 in 13. The virtual pointers are isomorphically mapped to display pointers 44.1 and 44.2 in 14.

FIG. 15.2 shows the displacement of pointer objects 40.1 and 40.2 to new positions. The pointer objects moved the same relative distance over the touch plane, while maintaining their initial height values. The pointer objects are isomorphically mapped to 11 as before. Note that 41.1 and 41.2 moved the same relative distance and maintained their respective z coordinate values. The pointers in 11 are mapped by the HiC 21 processor, while still using Equation 103.3 as the scaling function in Equation 103.1, to establish new positions for focal points 42.1 and 42.2 in 12. The relative distances that the focal points moved are no longer equal, with 42.2 travelling half the relative distance of 42.1 in this case. As before, the focal points are mapped by HiF 22 to establish virtual pointers 43.1 and 43.2 in 13 and virtual pointers, in turn are isomorphically mapped to display pointers 44.1 and 44.2 in 14.

The effect of the proposed transformation is to change a relative pointer object 40.i movement in the controller 11 space to scaled relative movement of a display pointer 44.i in the feedback 14 space, so that the degree of scaling may cause the display pointer 44.i to move slower, at the same speed or faster than the relative movement of pointer object 40.i.

### Example 4

In this example reference is made to FIGS. 16.1 to 16.3. A controller 10 that provides at least a two-dimensional input coordinate can be used.

The method for human-computer interaction (HCI) on a graphical user interface (GUI) includes the step of tracking the movement of a pointer object 40 on a touch sensitive input device (C) 10. The tracked pointer object is isomorphically mapped to establish a pointer input data coordinate 41 in the virtual control space (vC) 11. The HiC processor 21 establishes a focal point 42 for the pointer coordinate in the virtual interaction space (VIS) 12. The CiR processor 23 establishes a grid-based layout object 52.1 that contains N cells. Each cell may be populated with a virtual object 52.i, where 2≦i≦10, which contains a fixed interaction coordinate centred within the cell, by the CiR processor 23. The Ip processor 25 calculates, for each cell, a normalised relative distance rᵢₚ between the focal points 42 and interaction coordinate of virtual object 52.i, based on the geometry and topology of VIS 12, and updates these values whenever the position of the focal point 42 changes. The HiF processor 22 establishes a virtual pointer 43 and virtual objects 53.i in the feedback buffer 13, and calculates and continuously updates the positions and sizes of 43 and 53.i, using a function or algorithm based on the relative distances rᵢₚ in VIS 12 as calculated by the Ip processor 25. The virtual pointer 43 and virtual objects 53.i are mapped isomorphically to a visual pointer 44 and visual objects 54.i in the visual display feedback space (F) 14.

FIG. 16.1 shows a case where no pointer object is present in 10. The isomorphic transformation does not establish a pointer coordinate in 11 and the HiC processor 21 does not establish a focal point in VIS 12. The CiR processor 23 establishes a grid-based layout container 52.1 with 9 cells, and populates each cell with a virtual object 52.i, where 2<i<10, with a fixed interaction coordinate centred within the cell. With the focal points 42 absent in VIS 12, the Ip processor sets rᵢₚ=1 for all values of i. In this case, the HIF processor 22 may perform an algorithm, such as the following, to establish virtual objects 53.1 in the virtual feedback buffer 13:
1. The grid-based layout container is mapped to a virtual container object that consumes the entire space available in 14. The virtual container object is not visualised, but its width w_{53.1} and height h_{53.1} are used to calculate the location and size for each cell's virtual object 53.i.
2. Assign a size factor of sƒᵢ=1 for each cell that does not contain a virtual object in VIS 12.
3. Calculate a relative size factor sƒᵢ for each cell that contains a virtual object in the VIS 12 as a function of the normalised relative distance rᵢₚ between the focal points 42 and the interaction coordinate of the virtual object 52.i, as calculated by Ip 25 in VIS 12. The function for the relative size factor may be:

$${sf}_{i} = \frac{{sf}_{max}}{1 + ( \frac{{sf}_{max}}{{sf}_{min}} - 1 ) \cdot {r}_{ip}^{q}} , \qquad ( Equation 104.1 )$$

where sƒₘᵢₙ is the minimum allowable relative size factor with a range of values 0<sƒₘᵢₙ≦1, sƒₘₐₓ is the maximum allowable relative size factor with a range of values sƒₘₐₓ≧1 and q is a free parameter determining how strongly the relative size factor magnification depends upon the normalised relative distance r_{ip.}
4. Calculate the width w_{53.i} of virtual object 53.i as a function of all the relative size factors contained in the same row as the virtual object. A function for the width may be:

$${w}_{53. i} = \frac{{w}_{53.1} \cdot {sf}_{i}}{{\sum }_{i = a}^{ } {sf}_{i}} , \qquad ( Equation 104.2 )$$

where a is the index of the first cell in a row and b is the index of the last index in a row.
5. Calculate the height h_{53.i} of virtual object 53.i as a function of all the relative size factors contained in the same column as the virtual object. A function for the height may be:

$${h}_{53. i} = \frac{{h}_{53.1} \cdot {sf}_{i}}{{\sum }_{i = a}^{b } {sf}_{i}} , \qquad ( Equation 104.3 )$$

where a is the index of the first cell in a column and b is the index of the last index in a column.
6. Calculate positions for each virtual object by sequentially packing them in the cells of the grid-based container.
7. Virtual objects 53.i with larger relative size factors sƒᵢ are placed on top of virtual objects with smaller relative size factors.

In the current case, where focal points 42 is absent and rᵢₚ=1 for all values of i, the HiF processor 22 assigns equal widths and equal heights to each virtual object. The result is a grid with equally distributed virtual objects. The virtual pointer 43 and virtual objects 53.i are mapped isomorphically to a visual pointer 44 and visual objects 54.i in the visual display feedback space (F) 14.

On the introduction of a pointer object 40 in control space 10, a focal points 42 and virtual objects 52.i are established and normalised relative distances rᵢₚ are calculated in VIS 12 through the process described above. The application of the algorithm and functions implemented by the HiF processor 22, as described above, leads to the arrangements of visual objects 54.i in the visual display feedback space 14 as shown in FIG. 16.2. In this case, visual object 54.6 is much larger than the other visual objects, due to its proximity to visual pointer 44.

On the displacement of pointer object 40 in control space 10, the position of focal points 42 is updated, while virtual objects 52.i are established, and normalised relative distances rᵢₚ are calculated as before. The application of the algorithm and functions implemented by the HiF processor 22 as described above, leads to the arrangements of visual objects 54.i in the visual display feedback space 14 as shown in FIG. 16.3. In this case visual, object 54.4 is much larger than the other visual objects, due to its proximity to visual pointer 44, while 54.8 is much smaller and the other objects are sized between these two.

The location of visual pointer 44 and the size and locations of visual objects 54.i are updated as changes to pointer object 40 are tracked, so that the resulting visual effect is that visual objects compete for space based on proximity to visual pointer 44, so that visual objects closer to the visual pointer 44 are larger than objects farther from 44. Note that by independently calculating the width and height of a virtual object 53.i, objects may overlap in the final layout in 13 and 14.

### Example 5

In this example reference is made to FIGS. 17.1 to 17.4. Any controller 10 that provides at least a three-dimensional multi-touch (3D-MT) input device can be used. The method for human-computer interaction (HCI) on a graphical user interface (GUI) includes a method, function or algorithm that combines the passage of time with the movement of a pointer object in the z-axis to dynamically navigate through a hierarchy of visual objects. The movement of a pointer object 40 is tracked on a 3D multi-touch input device (C) 10. The tracked pointer object is isomorphically mapped to establish a pointer input data coordinate 41 in the virtual control space (vC) 11. The HiC processor 21 establishes a focal point 42 for the pointer coordinate in the virtual interaction space (VIS) 12. The CiR processor 23 establishes a hierarchy of cells in VIS 12. Each cell may be populated with a virtual object, which contains a fixed interaction coordinate centered within the cell, by the CiR processor 23. The hierarchy of virtual objects is established so that a virtual object 52.i contains virtual objects 52.i.j. The virtual objects to be included in VIS 12 may be determined by using the CiRa 33 to modify the free parameters, functions or algorithms of the CiR processor 23. One such algorithm may be the following set of rules:
1. If no pointer object is present in control space 10, establish positions and sizes in VIS 12 for all virtual objects and their children.
2. If a pointer object is present in control space 10, with an associated focal point in VIS 12, establish positions and sizes in VIS 12 for all, or a subset, of the virtual objects and their children based on the z coordinate of the focal point and the following rules:
   a. If z<zₜₑ, where zₜₑ is the hierarchical expansion threshold, select the virtual object under the focal points object and let it, and its children, expand to occupy all the available space in VIS 12.
      i. If an expansion occurs, do not process another expansion unless:
         1. a time delay of t_{d} seconds has passed, or
         2. the movement direction has reversed so that z>zₜₑ+z_{hd}, where z_{hd} is a small hysteretic distance and z_{hd}<(z_{tc}−z_{ze}), with z_{tc} as defined below.
   b. If z>z_{tc}, where z_{tc} is the hierarchical contraction threshold, contract the current top level virtual object and its children, then reintroduce its siblings in VIS 12.
      i. If a contraction occurred, do not process another contraction unless:
         1. a time delay of t_{d} seconds has passed, or
         2. the movement direction has reversed so that z<z_{tc}−z_{hd}, where z_{hd} is as defined before.
      c. Note that zₜₑ<z<z_{tc.}

Using the methods, functions and algorithms described in Example 4, the HiF processor 22 establishes a virtual pointer 43 and virtual objects 53.i and 53.i.j in the feedback buffer 13. The virtual pointer 43 and virtual objects 53.i and 53.i.j are mapped isomorphically to a visual pointer 44 and visual objects 54.i and 54.i.j in the visual display feedback space 14.

FIG. 17.1 shows an initial case where no pointer object is present in 10. This condition triggers Rule 1. Using the methods, functions and algorithms described in Example 4, the hierarchy of virtual objects 52.i and 52.i.j in VIS 12, leads to the arrangements of visual objects 54.i and 54.i.j in the visual display feedback space 14.

In FIG. 17.2, a pointer object 40 is introduced in control space 10 with coordinate positions x, y and zₐ, so that zₐ>zₜₑ. This condition triggers Rule 2. Using the methods, functions and algorithms described in Example 4, the pointer object 40 in control space 10 is mapped to visual pointer 44 in the visual display feedback space 14. The hierarchy of virtual objects 52.i and 52.i.j in VIS 12 are mapped to rearrange visual objects 54.i and 54.i.j in the visual display feedback space 14 as shown. In this case, all the initial virtual objects are visible. Visual object 54.1 is much larger than its siblings 54.2-54.4, due to its proximity to the visual pointer 44.

FIG. 17.3 shows a displaced pointer object 40 in control space 10 with new coordinate positions x, y and z_{b}, so that z_{b}<zₐ and z_{b}<zₜₑ. This condition triggers Rule 2.a. The CiRa 33 modifies the free parameters, functions or algorithms of the CiR processor 23 so that it now establishes new positions and sizes only for the hierarchy of cells that contains virtual object 54.1 and its children 52.1.j. The effect is that virtual objects 52.2-52.4 are removed from VIS 12, while virtual object 52.1 and its children 52.1.j are expanded to occupy all the available space in VIS 12. Using the methods, functions and algorithms described in Example 4, the pointer object 40 in control space 10 is mapped to visual pointer 44 in the visual display feedback space 14. The hierarchy of virtual objects 52.1 and 52.1.j in VIS 12 are mapped to rearrange visual objects 54.1 and 54.1.j in the visual display feedback space 14 as shown. In this case, only visual object 54.1 and its children 54.1.j are visible. Visual object 54.1.1 is much larger than its siblings (54.1.2-54.1.4) due to its proximity to the visual pointer 44.

FIG. 17.4 shows pointer object 40 in control space 10 at the same position (x, y and z_{b}) for more than t_{d} seconds. This condition triggers Rule 2.a.i.1. The CiRa 33 again modifies the free parameters, functions or algorithms of the CiR processor 23 so that it now establishes new positions and sizes only for the hierarchy of cells that contains virtual object 54.1.1. The effect is that virtual objects 52.2-52.4, as well as virtual objects 52.1.2-52.1.4 are removed from VIS 12, while virtual object 52.1.1 is expanded to occupy all the available space in VIS 12. Using the methods, functions and algorithms described in Example 4, the pointer object 40 in control space 10 is mapped to visual pointer 44 in the visual display feedback space 14. The hierarchy of virtual objects 52.1.1 in VIS 12 is mapped to rearrange visual objects 54.1 and 54.1.1 in the visual display feedback space 14 as shown. In this case, only visual objects 54.1 and 54.1.1 are visible and occupy all the available space in in the visual display feedback space 14.

In a further case, a pointer object 40 is introduced in control space 10 coordinate positions x, y and zₐ, so that zₐ>zₜₑ. This leads to the arrangement of visual pointer 44 and visual display objects 54.i and 54.i.j in the visual display feedback space 14 as shown before in FIG. 17.2. The pointer object 40 is next displaced in control space 10 to coordinate positions x, y and z_{b}, so that z_{b}<zₐ and z_{b}<zₜₑ. This leads to the arrangement of visual pointer 44 and visual objects 54.1 and 54.1.j in the visual display feedback space 14 as shown before in FIG. 17.3. The pointer object 40 displacement direction is now reversed to coordinate positions x, y and z_{c}, so that z_{b}<z_{c}<zₐ and z_{c}>zₜₑ+z_{td}. The pointer object 40 displacement direction is again reversed to coordinate positions x, y and z_{b}, so that z_{b}<zₜₑ. This condition triggers Rule 2.a.i.2, which leads to the arrangement of visual pointer 44 and visual objects 54.1 and 54.1.1 in the visual display feedback space 14 as shown before in FIG. 17.4. The pointer object 40 displacement direction is again reversed to coordinate positions x, y and z_{d}, so that z_{b}<z_{c}<z_{d}<zₐ and z_{d}>z_{tc}. This condition triggers Rule 2.b, which leads to the arrangement of visual pointer 44 and visual objects 54.1 and 54.1.j in the visual display feedback space 14 as shown before in FIG. 17.3. If the pointer object 40 is maintained at the same position (x, y and z_{d}) for more than t_{d} second Rule 2.b.i.1 is triggered, otherwise if the pointer object 40 displacement direction is reversed to coordinate positions x, y and zₑ, so that zₑ<z_{d} and zₑ<z_{tc}−z_{td}, Rule 2.b.i.2 is triggered. Both these conditions lead to the arrangement of visual pointer 44 and visual objects visual display objects 54.i and 54.i.j in the visual display feedback space 14 as shown before in FIG. 17.2.

### Example 6

In a further example of the invention reference is made to FIGS. 18.1 to 18.6. The method for human computer interaction (HCI) on a graphical user interface (GUI) includes the step of tracking the movement of a pointer object 40 on a touch sensitive input device 10. In this example any controller 10 that provides at least a two-dimensional input coordinate can be used. The tracked pointer object is isomorphically mapped to establish a pointer input data coordinate 41 in the virtual control space 11. The HiC processor 21 establishes a focal point 42 for the pointer coordinate in the virtual interaction space (VIS) 12. The CiR processor 23 populates VIS 12 with N virtual objects 52.i and establishes for each object a location and size, so that the objects are distributed equally over VIS 12. The CIR processor 23 also establishes a fixed interaction coordinate centred within each object. The HiF processor 22 establishes a virtual pointer 43 and virtual objects 53.i in the feedback buffer 13, and calculates and updates the size and position of the feedback objects 53.i to maintain the equal distribution of objects in the feedback buffer 13. The virtual pointer 43 and virtual objects 53.i are mapped isomorphically to a visual pointer 44 and visual objects 54.i in the visual display feedback space 14.

FIG. 18.1 shows a case where no pointer object is present in 10. The isomorphic transformation does not establish a pointer coordinate in 11 and the HiC processor 21 does not establish a focal point in VIS 12. The CiR processor 23 establishes 16 virtual objects 52.i, where 1≦i≦16, each with a fixed interaction coordinate, location and size so that the virtual objects are distributed equally over VIS 12. HiF processor 22 assigns the size and position of the feedback objects 53.i to maintain the equal distribution of objects in the feedback buffer 13. The feedback objects 53.i are mapped isomorphically to visual objects 54.i in the visual display feedback space 14.

On the introduction of a pointer object 40 in control space 10 as shown in FIG. 18.2, a focal point 42 and virtual objects 52.i are established through the process described above. The HiF processor 22 assigns the size and position of the virtual objects 53.i to maintain the equal distribution of objects in the feedback buffer 13, but if the focal point 42 falls within the bounds of a virtual object, thereby selecting the virtual object, the HiF processor will emphasize the selected virtual object's corresponding feedback object in the feedback buffer 13 and de-emphasize all other virtual object's corresponding feedback objects. FIG. 18.2 demonstrates a case where the focal point 42 falls within the bounds of virtual object 52.16. The corresponding feedback object 53.16 will be emphasised by increasing its size slightly, while all other feedback objects 53.1 to 53.15 will be de-emphasised by increasing their grade of transparency. The feedback objects 53.i are mapped isomorphically to visual objects 54.i in the visual display feedback space 14.

The CiC processor 24 continuously checks if the focal point 42 falls within the bounds of one of the virtual objects 52.i. If the focal point stays within the bounds of the same virtual object for longer than a short time period t_{d}, a command to prepare additional objects and data is send to the computer. The CiR and CiRa processors, process the additional data and object information to determine if some virtual objects should no longer be present in VIS 12 and/or if additional objects should be introduced in VIS 12. FIG. 18.3 shows a case where the focus point 42 stayed within the bounds of virtual object 52.16 for longer than t_{d} seconds. In this case, virtual objects 52.1 to 52.15 will no longer be introduced in VIS 12, while new secondary objects 52.16.j, where 1≦j≦3, with virtual reference point 62.1, located on the virtual object 52.16's virtual interaction coordinate, are introduced in VIS 12 at a constant radius r_{d} from virtual reference point 62.1, and at fixed angles θⱼ. Tertiary objects 52.16.j.1, representing the virtual objects for each secondary virtual object, along with a second virtual reference point 62.2, located in the top left corner, are also introduced in VIS 12. The Ip 25 calculates, based on the geometry and topology of VIS 12:
a vector \vec{r}₁ₚ between reference point 62.1 and focal point 42,
a vector \vec{r}₂ₚ between reference point 62.2 and focal point 42,
a set of vectors \vec{r}₁ⱼ between reference point 62.1 and the interaction coordinates of the secondary virtual objects 52.16.j,
a set of vectors \vec{r}ₚⱼ₁ that that are the orthogonal projections of vector \vec{r}₁ₚ onto vectors \vec{r}_{1j.}
   The Ip continuously updates vectors \vec{r}₁ₚ, \vec{r}₂ₚ and \vec{r}ₚⱼ₁ whenever the position of the focal point 42 changes. The HIF processor 22 maps the focal point 42 and the remaining primary virtual objects 52.i as before and isomorphically maps virtual reference point 62.1 to feedback. It then uses projection vectors \vec{r}ₚⱼ₁ to perform a function or an algorithm to establish the size and location for the secondary feedback objects 53.16.j in the virtual feedback buffer 13. Such a function or algorithm may be:
Isomorphically map an object's size to its representation in VIS 12.
Objects maintain their angular θⱼ coordinates.
Objects obtain a new distance r_{dj} from feedback reference point 63.1 for each feedback object 53.16.j using, for example, the following contraction function:

$${r}_{dj} = {r}_{d} ( 1 - {( \frac{c \cdot ‖ {\vec{r}}_{pj 1} ‖}{{r}_{d}} )}^{q} ) , \qquad ( Equation 106.1 )$$

where c is a free parameter that controls contraction linearly, and q is a free parameter that controls contraction exponentially.
   The HiF processor 22 also uses r_{dj} to determine if a tertiary virtual object should be mapped to feedback buffer 13 and what the object's size should be. Such a function or algorithm may be:
Find the largest r_{dj} and make the corresponding tertiary object 54.16.j.1 visible, then hide all other tertiary objects.
Increase the size of the visible tertiary object 54.16.j.1 in proportion to the value of r_{dj.}
Keep tertiary objects anchored to reference point 62.2.

In the current case, the application of the algorithm and functions implemented by the HiF processor 22, as described above, leads to the arrangements of the visual pointer 44 and visual objects 54.16, 54.16.j and 54.16.j.1 in the visual display feedback space 14 as shown in FIG. 18.3. With the focal point located at the same position as virtual reference point 62.1, the secondary visual objects 54.16.j are placed a constant radius r_{d} away from feedback reference point 63.1 and at fixed angles θⱼ, while no tertiary visual objects 54.16.j.1 are visible.

FIG. 18.4 shows a displaced pointer object 40 in control space 10. The position of focal point 42 is updated, while virtual objects 52.i and 52.i.j are established, and vectors \vec{r}₁ₚ, \vec{r}₂ₚ and \vec{r}ₚⱼ₁ are calculated as before. The application of the algorithm and functions implemented by the HiF processor 22 as describe above, leads to the arrangements of visual objects 54.16, 54.16.j, 54.16.3.1 in the visual display feedback space 14 as shown in FIG. 18.4. Visual object 54.16.1 almost did not move, visual object 54.16.2 moved closer to visual object 54.16 and visual object 54.16.3 moved even closer than visual object 54.16.2 to visual object 54.16. Tertiary visual object 54.16.3.1 is visible and becomes larger, while all other tertiary visual object 54.16.3.k are not visible.

FIG. 18.5 shows a further displacement of pointer object 40 in control space 10, so that the focal point crossed secondary virtual object 52.16.3 and then continued on towards tertiary virtual object 52.16.3.1. The position of focal point 42 and all calculated values are updated. If a secondary virtual object is 52.16.j is selected, in this case using crossing-based selection, the CiRa 33 adapts the CiR processor 23 to now only load the preciously selected primary virtual object, the currently selected secondary virtual object and its corresponding tertiary virtual object. In this case, only primary virtual object 52.16, secondary virtual object 52.16.3 and tertiary virtual object 52.16.3.1 are loaded. The HiF processor 22 may now change so that:
no primary virtual objects 52.i are mapped to feedback buffer 13,
no secondary virtual objects 52.i.j are mapped to feedback buffer 13,
the selected secondary virtual object's tertiary virtual object takes over the available space in feedback buffer 13.
the selected secondary virtual object's tertiary virtual object further adjust its position so that if the focal point 42 moves towards the virtual reference point 62.2, the tertiary virtual object moves upwards, while if the focal point 42 moves away from virtual reference point 62.2, the tertiary virtual object moves downwards.

The application of the algorithm and functions implemented by the HiF processor 22 as describe above, leads to the arrangements of visual objects 54.16, 54.16.3, 54,16.3.1 in the visual display feedback space 14 as shown in FIG. 18.5. Visual objects 54.16 and 54.16.j is no longer visible and visual object 54,16.3.1 expanded to take up the available visual feedback buffer space.

FIG. 18.6 shows a further upward displacement of pointer object 40 in control space 10. The position of focal point 42 and all calculated values are updated. The application of the algorithm and functions implemented by the HiF processor 22 as describe above, leads to the arrangements of visual object 54,16.3.1 in the visual display feedback space 14 as shown in FIG. 18.6. Visual object 54,16.3.1 moved downwards, so that more of its object is shown, in response the focal point moving closer to virtual reference point 62.2 in VIS 14.

### REFERENCES

[1] Card, S K, T P Moran & A Newell, The Psychology of Human-Computer Interaction, Lawrence Erlbaum Associates, Hillsdale, N.J., 1983.
[2] Bederson, B B & B Shneiderman, The Craft of Information Visualization—Readings and Reflections, Morgan Kaufmann, San Francisco, 2003.
[3] Dix, A, J Finlay, G D Abowd & R Beale, Human-Computer Interaction, 3rd Ed, Pearson Education, Essex, 2004.
[4] Bennett K B & J M Flach, Display and Interface Design—Subtle Science, Exact Art, CRC Press, Boca Raton, Fla., 2011.
[5] Norman, D A, The design of everyday things, Basic Books, New York, 1988, (originally published as Psychology of everyday things)
[6] Fitts, Paul M, “The information capacity of the human motor system in controlling the amplitude of movement,” Journal of Experimental Psychology, volume 47, number 6, June 1954, pp. 381-391. (Reprinted in Journal of Experimental Psychology: General, 121(3):262-269, 1992).
[7] Mackenzie, I S, “Fitt's Law as a research and design tool in human-computer interaction,” Human-computer Interaction, Vol 7, pp 91-139, 1992.
[8] Hick, W E, “On the rate of gain of information,” Quart. J. Exp. Psychol. 4, pp 11-26, 1952.
[9] Shannon C & Weaver W, The mathematical theory of communication, Univ. of Illinois Press, Urbana, 1949.
[10] Seow, S C, “Information Theoretic Models of HCI: A Comparison of the Hick-Hyman Law and Fitts' Law,” Human-computer Interaction, Vol 20, pp 315-352, 2005.
[11] Hewett, T T, Baecker, Card, Carey, Gasen, Mantei, Perlman, Strong & Verplank, “ACM SIGCHI Curricula for Human-Computer Interaction,” ACM SIGCHI, 1992, 1996, http://old.sigchi.org/cdg (accessed 31 May 2012)
[12] Coomans, M K D & H J P Timmermans, “Towards a Taxonomy of Virtual Reality User Interfaces,” Proc. Intl. Conf. on Information Visualisation (IV97), London, 27-29 Aug. 1997.
[13] Ording B, Jobs S P, Lindsay D J, “User interface for providing consolidation and access”, U.S. Pat. No. 7,434,177, Oct. 7, 2008.
[14] Zhai S, Conversy S, Beaudouin-Lafon M, Guiard Y, “Human on-line response to target expansion,” Proc CHI 2003, pp 177-184, 2003.
[15] Blanch R, Guiard Y, Beaudouin-Lafon M, “Semantic pointing: Improving target acquisition with control-display ratio adaptation,” Proc. CHI'04, pp 519-526, 2004.

1. A method for human-computer interaction (HCI) on a graphical user interface (GUI) comprising:
tracking the position or movement of a user's body or part of it relative to an input device or with the input device in a control space;
facilitating human-computer interaction by means of an interaction engine, which includes the steps of
establishing a virtual interaction space(vIS), distinct from the control space or computer memory directly associated with any human input device, and also distinct from a display space or memory directly associated with any human output device;
establishing and referencing one or more virtual objects with respect to the virtual interaction space;
establishing and referencing one or more focal points in the virtual interaction space in relation to the tracked position or movement in the control space;
applying one or more interaction functions to determine the interaction between one or more focal points and the virtual objects in the virtual interaction space and/or to determine one or more commands to be executed; and
applying a feedback function to determine what content of the virtual interaction space is to be presented to the user as feedback, and in which way the content is to be displayed; and
providing feedback to the user in a sensory feedback space.

2. The method of claim 1, wherein establishing and referencing one or more focal points in the virtual interaction space in relation to the tracked position and/or movement in the control space is effected by a processor that executes one or more Control functions (“a Human interaction Control (HiC) processor”).

3. The method of claim 2, wherein the HiC processor takes user input data from the control space to give effect to the reference of the focal point in the interaction space.

4. The method of claim 3, wherein the HiC processor takes other user input data to be used as a variable by an interaction function or to change the characteristics of the focal point.

5. The method of claim 1, wherein an interaction function that determines interaction with the focal point or with objects in the interaction space, is executed by an Interaction (Ip)_processor.

6. The method of claim 5, wherein interaction between the focal point and the objects in the interaction space is nonlinear.

7. The method of claim 5, wherein the interaction function is configured for navigation between objects to allow navigation through the virtual interaction space between objects.

8. The method of claim 5, wherein the interaction function is specified so that objects in the virtual interaction space change their state or their status in relation to a relative position of a focal point.

9. The method of claim 5, wherein the interaction function that determines the interaction between the focal point and the objects in the interaction space is specified so the interaction of the focal point with the objects is in the form of interacting with all the objects or a predetermined collection of objects according to a degree of selection or a degree of interaction.

10. The method of claim 1, wherein the feedback function is executed by a Human interaction Feedback (HiF) processor.

11. The method of claim 10, wherein the feedback function is adapted to include a scaling function to determine a number of objects or a collection of objects in the interaction space to be displayed.

12. The method of claim 1, wherein a Response function determines selection and use of data stored in memory to establish and compose the virtual interaction space or objects in the virtual interaction space and the Response function is executed by a Computer interaction Response (CiR) processor.

13. The method of claim 1, wherein a Command function determines the data to be stored in memory or the one or more commands to be executed and the Command function is executed by a Computer interaction Command (CiC) processor.

14. The method of claim 2, wherein a Human interaction Control adaptor (HiCa), uses information from the virtual interaction space (vIS) to dynamically redefine the functioning of the HiC processor.

15. The method of claim 14, wherein the HiCa changes a Control function used by the HiC processor to determine or define at least one selected from a group consisting of: a position of the control space, a size of the control space, a functionality of the control space, or any combination thereof based at least in part on the position of the focal point in the virtual interaction space and/or to the position or dimensions of virtual objects in the virtual interaction space.

16. The method of claim 12, wherein a Computer interaction Response adaptor (CiRa) uses information from the virtual interaction space (vIS) to dynamically redefine functioning of the CiR processor.

17. The method of claim 10, wherein a Human interaction Feedback adaptor (HiFa), uses information from the virtual interaction space (vIS) to dynamically redefine functioning of the HiF processor.

18. The method of claim 13, wherein a Computer interaction Command adaptor (CiCa) uses information from the virtual interaction space (vIS) to dynamically redefine functioning of the CiC processor.

19. The method of claim 5, wherein an Interaction Processor adaptor (Ipa) uses information from the virtual interaction space (vIS) to dynamically redefine functioning of the Ip processor.

20. The method of claim 1, wherein there is at least a partial overlap between any one or more of the virtual interaction space, the control space, and the sensory feedback space.

21. The method of claim 20, wherein the method the virtual interaction space and the feedback space overlap, and each virtual object is associated with an interaction state in the virtual interaction space and a display state.

22. The method of claim 20, wherein the virtual interaction space and the feedback space overlap and each virtual object is associated with a separate display position based on interaction with a focal point in the virtual interaction space.

23. The method of claim 20, wherein the virtual interaction space and the feedback space overlap and positions of objects in the virtual interaction space are determined based on relative distances between virtual objects and one or more focal points and on time derivatives.

24. The method of claim 1, wherein the virtual interaction space is provided with more than one dimension.

25. The method of claim 1, further comprising: establishing a coordinate system or a reference system in the virtual interaction space.

26. The method of claim 25, wherein the virtual objects in the interaction space are virtual data objects and each virtual object is referenced at a point in time in terms of the coordinate system, and each virtual object is configured with a state that represents one or more of the coordinates of a virtual object, a function of the virtual object, and a behaviour of the virtual object.

27. The method of claim 26, wherein the focal point is associated with a state that represents one or more of coordinates of the focal point, function of the focal point, and behaviour of the focal point.

28. The method of claim 26, wherein a state associated with a virtual object in the virtual interaction space is changed in response to a change in a state of a focal point or a change in a state associated with another virtual object in the virtual interaction space.

29. The method of claim 1, wherein a scalar field or a vector field is defined in the virtual interaction space.

30. The method of claim 1, wherein applying one or more interaction functions to modify one or more properties of one or more of the virtual objects comprises applying one or more mathematical functions to determine distant interaction of a focal point and the virtual objects in the virtual interaction space, and wherein interaction from the distance includes absence of contact between the focal point and a virtual object in the virtual interaction space.

31. The method of claim 1, wherein establishing and referencing one or more virtual objects with respect to the virtual interaction space comprises: applying a non-isomorphic function that determines the mapping of object positions from the virtual interaction space to a display space.

32. The method of claim 1, wherein establishing and referencing one or more virtual objects with respect to the virtual interaction space comprises: applying a non-isomorphic function to focal point positions and virtual object positions to determine mapping of a position of a virtual object in the virtual interaction space to a position in a display space.

33. The method of claim 1, wherein establishing and referencing one or more virtual objects with respect to the virtual interaction space comprises: applying a non-isomorphic function that determines mapping of virtual object sizes from the virtual interaction space to a display space.

34. The method of claim 1, wherein establishing and referencing one or more virtual objects with respect to the virtual interaction space comprises: applying a non-isomorphic function that determines the mapping of a state of a virtual object from the virtual interaction space to a display space.

35. The method of claim 1, further comprising: applying a non-isomorphic function or algorithm that uses a focal point position and a position of a virtual object in the virtual interaction space to update the position of the virtual object in the virtual interaction space.

36. The method of claim 1, further comprising: applying a non-isomorphic function that uses a focal point position and a position of a virtual object in the virtual-interaction space to update a size of the virtual object in the virtual interaction space.

37. The method of claim 1, further comprising: applying a non-isomorphic function that uses a focal point position and a position of a virtual object in the virtual interaction space to update a position and a size of the virtual object in the virtual interaction space.

38. The method of claim 1, further comprising: applying a non-isomorphic function that uses a focal point position and a position of a virtual object in the virtual interaction space to update a state of the virtual object in the virtual interaction space.

39. The method of claim 1, further comprising: applying a non-isomorphic function that uses a focal point position and a position of a virtual object in the virtual interaction space to determine the mapping of the position of the virtual object positions in the virtual interaction space to a display space as well as to update the position of the virtual object in the virtual interaction space.

40. The method of claim 1, further comprising: applying a non-isomorphic function that determines mapping of a size of a virtual object from the virtual interaction space to the sensory feedback space.

41. The method of claim 1, further comprising: applying a non-isomorphic function that determines mapping of virtual object positions and-sizes from the virtual interaction space to the sensory feedback space.

42. The method of claim 1, further comprising: applying a non-isomorphic function that determines mapping of a state of a virtual object from the virtual interaction space to the sensory feedback space.

43. The method of claim 1, wherein the position of a focal point in the virtual interaction space in relation to a position of a boundary of a virtual object in the virtual interaction space to identify an interaction function in response to the position of the focal point crossing the boundary of the virtual object in the virtual interaction space.

44. The method of claim 1, wherein time derivatives of the user input data are used to identify an interaction function.

45. The method of claim 29, wherein one or more properties of the scalar field or the vector field fields in the virtual interaction space are dynamically changed based on a position a state of one or more virtual objects in the virtual interaction space.

46. The method of claim 1, further comprising: changing one or more of a geometry of and a topology of the virtual interaction space, based on positions or properties of one or more virtual objects in the virtual interaction space.

47. The method of claim 1, wherein non-linear, continuous and dynamic interaction is established between a focal point and a virtual object in the virtual interaction space based on an algorithm based on a position of the focal point in the control space.

48. An engine for human-computer interaction on a GUI, comprising:
a means for establishing a virtual interaction space distinct from a control space or computer memory directly associated with a human input device, and also distinct from a display space or memory directly associated with a human output device;
a means for establishing and referencing one or more virtual objects with respect to the virtual interaction space;
a means for establishing and referencing one or more focal points in the virtual interaction space in relation to the tracked position or movement in a control space;
a means for calculating an interaction function to determine an interaction between one or more focal points and one or more virtual objects in the virtual interaction space or to determine one or more commands to be executed; and
a means for calculating a feedback function to determine what content of the virtual interaction space is to be presented to a user as feedback in a feedback space, and in which way the content is to be presented.

49. The engine of claim 48, wherein the means for establishing and referencing one or more focal points in the interaction space in relation to the tracked position or movement in the control space comprises a processor that executes one or more Control functions or algorithms (a “Human interaction Control (HiC) processor”).

50. The engine of claim 49, wherein the HiC processor receives user input data from the control space to determine a the reference of a focal point in the virtual interaction space.

51. The engine of claim 50, wherein the HiC processor receives other user input data to interact with one or more virtual objects in the virtual interaction space or to change one or more characteristics of a focal point.

52. The engine of claim 48, further comprising an Interaction (Ip) processor configured determine an interaction of a focal point and a virtual object in the virtual interaction space.

53. The engine of claim 52, wherein the interaction function is configured for navigation between virtual objects to allow navigation through the virtual interaction space between virtual objects.

54. The engine of claim 48, further comprising which includes a Human interaction Feedback (HiF) processor configured to execute a Feedback function.

55. The engine of claim 48, further comprising a Computer interaction Response (CiR) processor configured to execute a Response function that determines selection and use of data stored in memory to establish and compose the virtual interaction space or one or more virtual objects in the virtual interaction space.

56. The engine of claim 48, further comprising a Computer interaction Command (CiC) processor configured to execute a Command function that determines data to be stored in the computer memory or the commands to be executed.

57. The engine of claim 49, further comprising a Human interaction Control adaptor (HiCa) that uses information from the virtual-interaction space (vIS) to dynamically redefine the functioning of the HiC processor.

58. The engine of claim 57, wherein the HiCa is configured to change the Control function to determine a position, a size or a functionality of the control space in relation to a position of a focal point in the virtual interaction space or in relation to positions or dimensions of virtual objects in the virtual interaction space.

59. The engine of claim 55, further comprising a Computer interaction Response adaptor (CiRa), which uses information from the virtual interaction space (vIS) to dynamically redefine functioning of the CiR processor.

60. The engine of claim 54, further comprising a Human interaction Feedback adaptor (HiFa), which uses information from the virtual interaction space (vIS) to dynamically redefine functioning of the HiF_processor.

61. The engine of of claim 56, further comprising: a Computer interaction Command adaptor (CiCa), which uses information from the virtual interaction space (vIS) to dynamically redefine functioning of the CiC processor.

62. The engine of claim 52, further comprising an Interaction Processor adaptor (Ipa), which uses information from the virtual interaction space (vIS) to dynamically redefine functioning of the Ip processor.

63-64. (canceled)
